(19) United States
(12) Patent Application Publication
(10) Pub. No.: US 2025/0087906 A1
(43) Pub. Date: Mar. 13, 2025

(54) ANTENNA-IN-MODULE - ANTENNA-IN-PACKAGE, CHIP, AND ELECTRONIC DEVICE

(71) Applicant: Huawei Technologies Co., Ltd., Shenzhen (CN)

(72) Inventors: Chen-Fang Tai, Taipei (CN); Chih-Wei Hsu, Taipei (CN); Chien-Ming Lee, Taipei (CN); En Tso Yu, Taipei (CN); Chih Yu Tsai, Taipei (CN)

(21) Appl. No.: 18/724,559

(22) PCT Filed: Dec. 8, 2022
(86) PCT No.: PCT/CN2022/137702

§ 371 Date: Dec. 3, 2024

(30) Foreign Application Priority Data
Dec. 29, 2021 (CN) 202111649196.3

(51) Int. Cl. H01Q 21/29; H01Q 1/24; H01Q 21/26

(52) U.S. Cl. CPC H01Q 21/29; H01Q 1/243; H01Q 21/26

(57) ABSTRACT

An antenna-in-module includes a ground plate, three radiating elements, and two feed stubs. A first radiating element and a ground plate are arranged at an interval along a Z-axis and are disposed opposite to each other. The first radiating element and a second radiating element are arranged at an interval along an X-axis. A first gap between the first radiating element and the second radiating element extends along a Y-axis. A third radiating element and the second radiating element are arranged at an interval along the Z-axis and are disposed opposite to each other. At least a part of a first feed stub is disposed in a first aperture that includes space between the first gap and the ground plate. At least a part of a second feed stub is disposed in a second aperture that includes space between the second radiating element and the third radiating element.

### CROSS-REFERENCE TO RELATED APPLICATIONS

This application is a National Stage of International Application No. PCT/CN2022/137702, filed on Dec. 8, 2022, which claims priority to Chinese Patent Application No. 202111649196.3, filed on Dec. 29, 2021, both of which are hereby incorporated by reference in their entireties.

### TECHNICAL FIELD

This application relates to the field of communication technologies, and in particular, to an antenna-in-module, an antenna-in-package, a chip, and an electronic device.

### BACKGROUND

As an apparatus for transmitting and receiving electromagnetic waves, an antenna is an important part of an electronic device. In the conventional technology, in addition to a broadside antenna (broadside antenna, BR Antenna) disposed in the electronic device, an end-fire antenna (end-fire antenna, EF Antenna) may be further disposed, to increase radiation coverage of the antenna in the electronic device. Since an electronic device like a mobile phone or a tablet computer has a small side thickness, a broadside antenna and an end-fire antenna that are separately disposed occupy too much space to be placed on a side of the electronic device.

### SUMMARY

This application provides an antenna-in-module, an antenna-in-package, a chip, and an electronic device. An area of the antenna-in-module can be reduced by reusing and co-structuring a part of an antenna-in-module of a broadside antenna and a part of an antenna-in-module of an end-fire antenna.

According to an aspect of embodiments of this application, an antenna-in-module is provided, including a ground plate, a first radiating element, a second radiating element, a third radiating element, a first feed stub, and a second feed stub. The first radiating element and the ground plate are arranged at an interval along a virtual Z-axis and are disposed opposite to each other. The first radiating element and the second radiating element are arranged at an interval along a virtual X-axis. A first gap between the first radiating element and the second radiating element extends along a virtual Y-axis. The third radiating element and the second radiating element are arranged at an interval along the virtual Z-axis and are disposed opposite to each other. The first radiating element, the second radiating element, and the third radiating element are separately in a coupling connection to the ground plate. At least a part of the first feed stub is disposed in a first aperture. The first aperture includes space between the first gap and the ground plate. At least a part of the second feed stub is disposed in a second aperture. The second aperture includes space between the second radiating element and the third radiating element. The X-axis, the Y-axis, and the Z-axis are perpendicular to each other.

According to the antenna-in-module provided in embodiments of this application, the first feed stub, the first radiating element, and the second radiating element may implement vertical polarization of a broadside antenna. The second feed stub, the second radiating element, and the third radiating element may implement vertical polarization of an end-fire antenna. Some structures of the broadside antenna and the end-fire antenna are reused and co-structured, so that a radiation pattern of the antenna-in-module may be a pattern in a broadside direction or a pattern in an end-fire direction. In this way, the antenna-in-module can achieve a large radiation coverage range in a small area, thereby improving an antenna gain.

In a possible implementation, the first radiating element includes a first radiator and a second radiator that are arranged at an interval along the Y-axis. A second gap between the first radiator and the second radiator extends along the X-axis. The second radiating element includes a third radiator and a fourth radiator that are arranged at an interval along the Y-axis. A third gap between the third radiator and the fourth radiator extends along the X-axis. The third radiating element includes a fifth radiator and a sixth radiator that are arranged at an interval along the Y-axis. A fourth gap between the fifth radiator and the sixth radiator extends along the X-axis.

Each radiating element is disposed as two parts that are separated by using a gap, which is beneficial to position arrangement of the feed stub.

In a possible implementation, the antenna-in-module further includes a third feed stub. At least a part of the third feed stub is disposed in a third aperture, and the third aperture includes a second gap and space between the third gap and the ground plate.

The third feed stub, the first radiating element, and the second radiating element may form a horizontally polarized broadside antenna, to implement dual-polarization of the broadside antenna, further increase a radiation coverage range of the antenna-in-module, and improve an antenna gain. In addition, electric fields between horizontal polarization and vertical polarization of the broadside antenna are orthogonal, so that the dual-polarized broadside antenna is highly isolated and can be operated simultaneously.

In a possible implementation, the antenna-in-module further includes a fourth radiating element and a fourth feed stub. The fourth radiating element is disposed between the third radiating element and the second radiating element and is in a coupling connection to the ground plate. The fourth radiating element includes a seventh radiator and an eighth radiator. The seventh radiator is disposed between the third radiator and the fifth radiator, and the eighth radiator is disposed between the fourth radiator and the sixth radiator. The fourth feed stub includes a first feed structure and a second feed structure. The first feed structure is in a coupling connection to the seventh radiator, and the second feed structure is in a coupling connection to the eighth radiator.

The fourth radiating element and the fourth feed stub may form a horizontally polarized end-fire antenna, to implement dual-polarization of the end-fire antenna, further increase a radiation coverage range of the antenna-in-module, and improve an antenna gain. In addition, electric fields between horizontal polarization and vertical polarization of the end-fire antenna are orthogonal, so that the dual-polarized end-fire antenna is highly isolated and can be operated simultaneously.

In a possible implementation, the antenna-in-module includes a first grounding element, a second grounding element, a third grounding element, and a fourth grounding element. The first grounding element is connected between the first radiator and the ground plate, and the second grounding element is connected between the second radiator and the ground plate. The third grounding element is connected between the third radiator and the ground plate, and the third grounding element is connected to an end that is of the third radiator and that faces the first radiator. The fourth grounding element is connected between the fourth radiator and the ground plate, and the fourth grounding element is connected to an end that is of the fourth radiator and that faces the second radiator. The seventh radiator is connected to the third grounding element, and the eighth radiator is connected to the fourth grounding element.

The four radiators of the first radiating element and the second radiating element are separately connected to the ground plate by using four grounding elements, and the two radiators of the fourth radiating element are indirectly grounded by using a grounding element corresponding to the second radiating element, so that compact arrangement of a ground structure can be implemented, and space utilization can be improved.

In a possible implementation, the third grounding element includes a first ground wall and a second ground wall. The first ground wall and the second ground wall are respectively connected to the third radiator at a first position and a second position. The first position and the second position are arranged at an interval on the third radiator. The first ground wall is located on a side that is of the third radiator and that is close to the fourth radiator. The seventh radiator is connected to the first ground wall, and a first switch is connected between the second ground wall and the ground plate. The fourth grounding element includes a third ground wall and a fourth ground wall. The third ground wall and the fourth ground wall are respectively connected to the fourth radiator at a third position and a fourth position. The third position and the fourth position are arranged at an interval on the fourth radiator. The third ground wall is located on a side that is of the fourth radiator and that is close to the third radiator. The eighth radiator is connected to the third ground wall, and a second switch is connected between the fourth ground wall and the ground plate.

Each of the third grounding element and the fourth grounding element is disposed as two parts of metal walls that are separated by using a hollow-out region, to reduce unnecessary resonance, and facilitate disposing of the first switch and the second switch. The switch may be configured to control whether to ground the second radiating element, to switch a pattern in a broadside direction or a pattern in an end-fire direction.

When the antenna-in-module is in an end-fire mode, the first switch and the second switch are controlled to be turned on, so that the second radiating element is grounded, to create a boundary condition in which electric fields on two sides of a vertical polarization radiation aperture of the end-fire antenna are the smallest. When the antenna-in-module is in a broadside mode, the first switch and the second switch are controlled to be turned off, so that a main radiation aperture of the end-fire antenna can return to the radiation aperture of the broadside antenna. In a possible implementation, the antenna-in-module further includes a third switch and a fourth switch. The third switch is connected between the fifth radiator and the sixth radiator, and the third switch is located at an end that is of the third radiating element and that is away from the first radiating element. The fourth switch is connected between the third radiator and the fourth radiator, and the fourth switch is located at an end that is of the second radiating element and that is close to the first radiating element.

When the antenna-in-module is in the broadside mode, the third switch is controlled to be turned on and the fourth switch is controlled to be turned off. When the antenna-in-module is in the end-fire mode, the third switch is controlled to be turned off and the fourth switch is controlled to be turned on. In this way, pattern operations in the broadside mode and the end-fire mode are achieved.

In a possible implementation, both the seventh radiator and the eighth radiator are disposed perpendicular to the ground plate. A first end of the seventh radiator is connected to the third grounding element, and a second end of the seventh radiator extends toward a side away from the eighth radiator. A first end of the eighth radiator is connected to the fourth grounding element, and a second end of the eighth radiator extends toward a side away from the seventh radiator.

In this way, impact of grounding of the fourth radiating element on the radiation pattern of the broadside antenna can be reduced as much as possible while a radiation aperture between the seventh radiator and the eighth radiator can be increased as much as possible.

In a possible implementation, the first feed stub extends along the X-axis, a projection of a first end of the first feed stub on an XY plane is located within a projection of the second gap on the XY plane, and a projection of a second end of the first feed stub on the XY plane is located within a projection of the third gap on the XY plane. The second feed stub extends along the Z-axis, and an end of the second feed stub is in a coupling connection to the second radiating element.

The first feed stub may cross the first gap, and excite the first radiating element and the second radiating element to form vertical polarization radiation of the broadside antenna in the first aperture. The second feed stub may cross space between the second radiating element and the third radiating element in a Z direction, and excite the second radiating element and the third radiating element to form vertical polarization radiation of the end-fire antenna in the second aperture.

In a possible implementation, the first gap includes a first sub-gap and a second sub-gap. The first sub-gap is located between the first radiator and the third radiator. The second sub-gap is located between the second radiator and the fourth radiator. The third feed stub extends along the Y-axis. A projection of a first end of the third feed stub on an XY plane is located within a projection of the first sub-gap on the XY plane, and a projection of a second end of the third feed stub on the XY plane is located within a projection of the second sub-gap on the XY plane.

The third feed stub may cross a gap through which the second gap communicates with the third gap, and the third feed stub may excite the first radiating element and the second radiating element to form horizontal polarization radiation in the third aperture.

In a possible implementation, the first grounding element includes a first ground segment, a second ground segment, and a third ground segment that are sequentially connected. The first ground segment is connected to the first radiator, the third ground segment is connected to the ground plate, the first ground segment and the third ground segment extend along the Z-axis, and the second ground segment extends along the XY plane.

The grounding element is disposed as a multi-segment bent structure, so that a height between the radiator and the ground plate is reduced while an electrical length is met, thereby reducing an overall size of the antenna-in-module.

In a possible implementation, the third ground wall includes a fourth ground segment, a fifth ground segment, and a sixth ground segment that are sequentially connected. The fourth ground segment is connected to the fourth radiator, the sixth ground segment is connected to the ground plate, the fourth ground segment and the sixth ground segment extend along the Z-axis, and the fifth ground segment extends along the XY plane.

The ground wall is disposed as a multi-segment bent structure, so that a height between the radiator and the ground plate is reduced while an electrical length is met, thereby reducing an overall size of the antenna-in-module.

In a possible implementation, the third radiating element reuses a partial structure of the ground plate.

The third radiating element may be a part of the ground plate, to reduce a size of the antenna-in-module, and facilitate a grounding design of the third radiating element.

In a possible implementation, the antenna-in-module includes a broadside antenna and an end-fire antenna. The broadside antenna includes the first radiating element, the second radiating element, the first feed stub, the third feed stub, and the ground plate. The end-fire antenna includes the second radiating element, the third radiating element, the fourth radiating element, the second feed stub, the fourth feed stub, and the ground plate.

The broadside antenna and the end-fire antenna co-structure and reuse the second radiating element, the third grounding element, and the fourth grounding element. The second radiating element may be used as at least a part of a radiator of each of the broadside antenna and the end-fire antenna, and the third radiating element may be used as a reference ground of the broadside antenna and a radiator of the end-fire antenna. Therefore, the antenna-in-module provided in embodiments of this application may greatly reduce an integration area of the broadside antenna and the end-fire antenna while integrating functions of the broadside antenna and the end-fire antenna.

In a possible implementation, the broadside antenna includes a broadside-vertical polarization pattern and a broadside-horizontal polarization pattern. The first feed stub feeds the first radiating element and the second radiating element to form the broadside-vertical polarization pattern, and the third feed stub feeds the first radiating element and the second radiating element to form the broadside-horizontal polarization pattern. The end-fire antenna includes an end-fire vertical polarization pattern and an end-fire horizontal polarization pattern. The second feed stub feeds the second radiating element and the third radiating element to form the end-fire vertical polarization pattern, and the fourth feed stub feeds the fourth radiating element to form the end-fire horizontal polarization pattern.

The antenna-in-module provided in embodiments of this application can implement a dual-polarized broadside antenna and a dual-polarized end-fire antenna, to implement polarization diversity of the antenna-in-module, thereby helping improve a transmission throughput and signal stability of a weak-signal region, and meeting a signal transmission requirement.

In a possible implementation, each of the first radiator, the second radiator, the third radiator, and the fourth radiator is shaped like a rectangle with a missing corner, and the first radiator, the second radiator, the third radiator, and the fourth radiator are centrosymmetric with respect to a center point.

An electrical length of the radiator may be increased by adding a missing corner to the radiator, and overall performance of the antenna-in-module is improved by disposing the four radiators to be centrosymmetric.

According to another aspect of embodiments of this application, an antenna-in-package is provided, including a transmitter and/or receiver chip and the foregoing antenna-in-module. The transmitter and/or receiver chip and the antenna-in-module are electrically connected and encapsulated in a same substrate.

The antenna-in-module may radiate an electromagnetic wave based on a received electromagnetic signal, and/or send an electromagnetic signal to the transmitter and/or receiver chip based on the received electromagnetic wave, to implement wireless communication. The antenna-in-package provided in embodiments of this application has advantages of a small area, large coverage, and a large antenna gain.

According to another aspect of embodiments of this application, a chip is provided, including a radio frequency module and the foregoing antenna-in-module.

The antenna-in-module and the radio frequency module may be integrated into one chip, to improve performance of the chip.

According to another aspect of embodiments of this application, an electronic device is provided, including the foregoing antenna-in-module, the foregoing antenna-in-package, or the foregoing chip.

The electronic device provided in embodiments of this application may be applied to a plurality of types of antennas by using the antenna-in-module provided in the foregoing embodiments of this application, so that a radiation pattern can be increased without increasing an occupied area of an antenna, and signal coverage and signal quality can be improved.

In a possible implementation, the electronic device includes a front side and a back side that are disposed opposite to each other. The front side and the back side are connected by using a middle frame. The middle frame includes a top, a right side part, a bottom, and a left side part that are sequentially connected. There are three antennas-in-module, one antenna-in-module is disposed on the back side of the electronic device and a distance between the antenna-in-module and an upper edge of the top does not exceed a first threshold, and the other two antennas-in-module are respectively disposed on the left side part and the right side part and a distance between the antenna-in-module and a left edge of the left side part and a distance between the antenna-in-module and a right edge of the right side part do not exceed a second threshold.

The three antennas-in-module are respectively disposed on the top, the left side part, and the right side part of the electronic device, and each antenna-in-module can perform independent beamforming and beam scanning, so that a large radiation coverage range can be achieved. In addition, the antenna-in-module is placed on a side edge of the electronic device or at a position close to the side edge, so that space of the electronic device can be effectively used, and space occupied by a circuit board and another existing electronic component inside the electronic device is reduced.

According to still another aspect of embodiments of this application, an electronic device is provided, including an antenna-in-module. The antenna-in-module may be operated as a broadside antenna and an end-fire antenna, and the antenna-in-module includes a first radiating element, a second radiating element, and a third radiating element. The first radiating element and the second radiating element are used as radiators of the broadside antenna to radiate an electromagnetic wave of the broadside antenna. The second radiating element and the third radiating element are used as radiators of the end-fire antenna to radiate an electromagnetic wave of the end-fire antenna.

In a possible implementation, the antenna-in-module includes a ground plate for grounding the broadside antenna and the end-fire antenna.

In a possible implementation, at least a part of the third radiating element may be formed by using the ground plate.

In a possible implementation, the antenna-in-module includes a substrate. The broadside antenna and the end-fire antenna are disposed on the substrate. A main radiation direction of the broadside antenna is a first radiation direction, and a main radiation direction of the end-fire antenna is a second radiation direction.

In a possible implementation, the first radiation direction is a direction perpendicular to the substrate, and the second radiation direction is a direction parallel to the substrate.

In a possible implementation, when the broadside antenna radiates, the antenna-in-module operates in a broadside mode, and when the end-fire antenna radiates, the antenna-in-module operates in an end-fire mode. The antenna-in-module switches between the broadside mode and the end-fire mode.

In a possible implementation, the antenna-in-module may switch between the broadside mode and the end-fire mode by using a switch.

In a possible implementation, the antenna-in-module may switch between the broadside mode and the end-fire mode based on a received signal.

In a possible implementation, both the broadside antenna and the end-fire antenna are dual-polarized antennas.

In a possible implementation, the broadside antenna includes a broadside-vertical polarization pattern and a broadside-horizontal polarization pattern, and the two patterns may be operated simultaneously.

In a possible implementation, the end-fire antenna includes an end-fire vertical polarization pattern and an end-fire horizontal polarization pattern, and the two patterns may be operated simultaneously.

Embodiments of this application provide an antenna-in-module, an antenna-in-package, a chip, and an electronic device. Compared with a conventional technology in which a broadside antenna and an end-fire antenna are directly placed together, a manner in which some structures of the broadside antenna and the end-fire antenna are reused and co-structured can greatly reduce an overall use area of the antenna-in-module, so that the antenna-in-module can be placed on a side of the electronic device. In addition, compared with a separate broadside antenna or end-fire antenna, the broadside antenna and the end-fire antenna in which some structures are reused and co-structured can greatly increase an antenna coverage angle and an antenna gain by increasing a radiation pattern.

### BRIEF DESCRIPTION OF THE DRAWINGS

FIG. 1 is a schematic diagram of a structure of an electronic device according to an embodiment of this application;

FIG. 2 is an exploded view of an electronic device according to an embodiment of this application;

FIG. 3 is an architecture of a communication system of an electronic device according to an embodiment of this application;

FIG. 4 is a schematic diagram of a packaging structure of an antenna-in-module according to an embodiment of this application;

FIG. 5 is a schematic diagram of a layout of an antenna-in-module in an electronic device according to an embodiment of this application;

FIG. 6 is a schematic diagram of a packaging structure of an antenna element of an antenna-in-module according to an embodiment of this application;

FIG. 7 is a schematic diagram of a structure of an antenna element of an antenna-in-module according to an embodiment of this application;

FIG. 8 is a schematic diagram of a structure of a broadside antenna in an antenna-in-module according to an embodiment of this application;

FIG. 9 is a schematic diagram of a structure of an end-fire antenna in an antenna-in-module according to an embodiment of this application;

FIG. 10 is a schematic planar expanded view of an antenna-in-module according to an embodiment of this application;

FIG. 11 is a topology diagram of a folded planar aperture structure of an antenna-in-module according to an embodiment of this application;

FIG. 12 is a schematic diagram of a structure of an antenna-in-module from another angle according to an embodiment of this application;

FIG. 13 is a side view of an antenna-in-module according to an embodiment of this application;

FIG. 14 is a schematic diagram of a structure of an antenna-in-module from another angle according to an embodiment of this application;

FIG. 15 is a side view of an antenna-in-module from another angle according to an embodiment of this application;

FIG. 16 is a schematic diagram of a structure of a metal wall according to an embodiment of this application;

FIG. 17 is a schematic top view of an antenna-in-module according to an embodiment of this application;

FIG. 18 is a radiation gain pattern of an antenna-in-module according to an embodiment of this application;

FIG. 19 is a diagram of a cumulative distribution function of an antenna gain of an antenna-in-module according to an embodiment of this application;

FIG. 20 is an antenna gain field pattern of an antenna-in-module on a YZ plane according to an embodiment of this application;

FIG. 21 is another schematic diagram of a structure of an antenna-in-module according to an embodiment of this application;

FIG. 22a is a broadside and end-fire vertical polarization radiation gain field pattern of the antenna-in-module provided in FIG. 21 in a low-frequency band;

FIG. 22b is a broadside and end-fire vertical polarization radiation gain field pattern of the antenna-in-module provided in FIG. 21 in a high-frequency band;

FIG. 23 is another schematic diagram of a structure of an antenna-in-module according to an embodiment of this application;

FIG. 24a is a broadside and end-fire horizontal polarization radiation gain field pattern of the antenna-in-module provided in FIG. 23 in a low-frequency band; and

FIG. 24b is a broadside and end-fire horizontal polarization radiation gain field pattern of the antenna-in-module provided in FIG. 23 in a high-frequency band.

### REFERENCE NUMERALS

100: electronic device; 101: central processing unit chip; 102: low-frequency baseband chip; 103: intermediate-frequency baseband chip; 104: antenna-in-package; 105: transmitter and/or receiver chip; 11: middle frame; 12: display; 13: rear cover; 14: cover; 15: PCB;
200: antenna-in-module: 20: substrate; 21: first radiating element; 211: first radiator; 212: second radiator; 22: second radiating element; 221: third radiator; 222: fourth radiator; 23: third radiating element; 231: fifth radiator; 232: sixth radiator; 24: fourth radiating element; 241: seventh radiator; 242: eighth radiator;
30: ground plate; 31: first feed stub; 311: first feed-in part; 32: second feed stub; 321: connection stub; 33: third feed stub; 331: second feed-in part; 34: fourth feed stub; 341: first feed structure; 342: second feed structure; 343: parasitic element; 351: first grounding element; 352: second grounding element; 361: third grounding element; 362: fourth grounding element; SW1: first switch; SW2: second switch; SW3: third switch; and SW4: fourth switch.

### DETAILED DESCRIPTION OF ILLUSTRATIVE EMBODIMENTS

The following describes terms that may be used in embodiments of this application.

Electrical connection: The electrical connection may be understood as physical contact and electrical conduction of components, and may also be understood as a form in which different components in a line structure are connected through physical lines that can transmit an electrical signal, such as a printed circuit board (printed circuit board, PCB) copper foil or a conducting wire.

Coupling: The coupling may be understood as direct coupling and/or indirect coupling. A “coupling connection” may be understood as a direct coupling connection and/or an indirect coupling connection. The direct coupling may also be referred to as an “electrical connection”. The “indirect coupling” may be understood as that two conductors are electrically conducted in a mid-air/non-contact manner. The “indirect coupling” may also be understood as capacitive coupling. For example, signal transmission is implemented by forming an equivalent capacitor through coupling in a gap between two spaced conductive members. A person skilled in the art may understand that a coupling phenomenon is a phenomenon that two or more circuit elements or electrical networks closely cooperate with and affect each other in input and output, so that energy is transmitted from one side to another side through interaction.

Turn-on: Two or more components are conducted or connected in the “electrical connection” or “coupling connection” manner to perform signal/energy transmission, which may be referred to as turn-on.

Connection: The connection may refer to a mechanical connection relationship or a physical connection relationship. That is, an A-B connection may mean that a fastening component (like a screw, a bolt, a rivet) exists between A and B, or that A and B are in contact with each other and are difficult to be separated.

Disposed opposite to each other: That A is disposed opposite to B may mean that A and B are disposed opposite to each other or face to face (opposite to, or face to face).

Aperture/Gap: The aperture/gap may be closed or semi-closed, open, or semi-open space enclosed between conductors. It should be understood that the aperture may be space filled with any dielectric/dielectric medium, including space filled with air or vacuum. In some embodiments, the aperture may refer to space through which a radiation signal may pass.

Electrical length: The electrical length may be indicated by a product of a physical length (namely, a mechanical length or a geometric length) and a ratio of transmission time of an electrical or electromagnetic signal in a medium to time required when the signal passes through a distance the same as the physical length of the medium in free space, and the electrical length may satisfy the following formula:

$$\overline{L} = L \times \frac{a}{b} ,$$

where

L is the physical length, a is the transmission time of the electrical or electromagnetic signal in the medium, and b is the transmission time in free space.

Alternatively, the electrical length may be a ratio of a physical length (namely, a mechanical length or a geometric length) to a wavelength of a transmitted electromagnetic wave. The electrical length may satisfy the following formula:

$$\overline{L} = \frac{L}{λ} ,$$

where

L is the physical length, and 2 is the wavelength of the electromagnetic wave.

In some embodiments of this application, a physical length of a radiator may be understood as an electrical length of the radiator+10%.

Wavelength: The wavelength or an operating wavelength may be a wavelength corresponding to a center frequency of a resonance frequency or a center frequency of an operating frequency band supported by an antenna. For example, it is assumed that a center frequency of a B1 uplink frequency band (a resonance frequency ranges from 1920 MHz to 1980 MHz) is 1955 MHz, the operating wavelength may be a wavelength calculated by using the frequency of 1955 MHz. The “operating wavelength” is not limited to the center frequency, and may alternatively be a wavelength corresponding to a resonance frequency or a non-center frequency of an operating frequency band.

Such limitations as collinearity, coplanarity, symmetry (for example, axisymmetricity or centrosymmetricity), parallelism, and perpendicularity mentioned in embodiments of this application are all for a current process level, and are not absolutely-strict definitions in mathematics. A deviation less than a predetermined threshold (for example, 1 mm, 0.5 m, or 0.1 mm) may exist between edges of two collinear radiation stubs or two collinear antenna elements in a horizontal direction. A deviation less than a predetermined threshold (for example, 1 mm, 0.5 m, or 0.1 mm) may exist between edges of two coplanar radiation stubs or two coplanar antenna elements in a direction perpendicular to a plane on which the two coplanar radiation stubs or two coplanar antenna elements are located. A deviation of a predetermined angle (for example, +5°, or)+10° may exist between two antenna elements that are parallel or perpendicular to each other.

The technical solutions provided in this application are applicable to an electronic device that uses one or more of the following communication technologies: a Bluetooth (Bluetooth, BT) communication technology, a global positioning system (global positioning system, GPS) communication technology, a wireless fidelity (wireless fidelity, Wi-Fi) communication technology, a global system for mobile communication (global system for mobile communication, GSM) communication technology, a wideband code division multiple access (wideband code division multiple access, WCDMA) communication technology, a long term evolution (long term evolution, LTE) communication technology, a 5G communication technology, and other future communication technologies.

The electronic device in embodiments of this application may be a mobile phone, a tablet computer, a notebook computer, a smart household, a smart band, a smart watch, a smart helmet, smart glasses, or the like. Alternatively, the electronic device may be a cellular phone, a cordless phone, a session initiation protocol (session initiation protocol, SIP) phone, a wireless local loop (wireless local loop, WLL) station, a personal digital assistant (personal digital assistant, PDA), a handheld device with a wireless communication function, a computing device or another processing device connected to a wireless modem, a vehicle-mounted device, a virtual reality/augmented reality/mixed reality device, an electronic device in a 5G network, an electronic device in a future evolved public land mobile network (public land mobile network, PLMN), or the like. This is not limited in embodiments of this application.

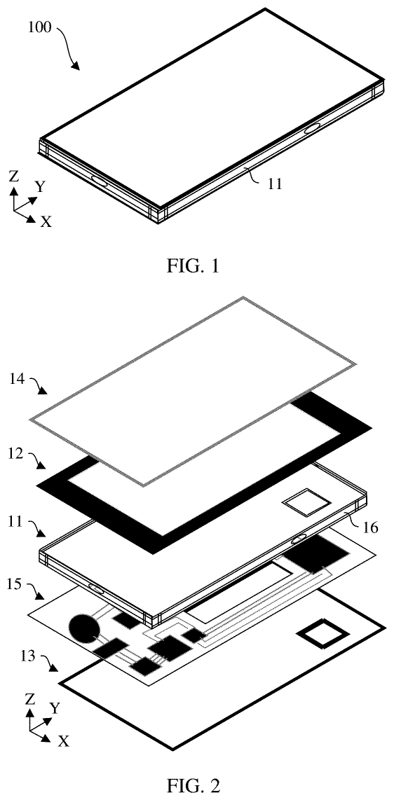

FIG. 1 is a schematic diagram of a structure of an electronic device according to an embodiment of this application. FIG. 2 is an exploded view of an electronic device according to an embodiment of this application. FIG. 1 and FIG. 2 show an example of an electronic device provided in this application. An example in which the electronic device is a mobile phone is used for description.

An electronic device 100 may include a middle frame (middle frame) 11, a display (display) 12, a rear cover (rear cover) 13, a cover (cover) 14, and a printed circuit board (printed circuit board, PCB) 15. The display 12 and the rear cover 13 are respectively connected to two sides of the middle frame 11, and the three are enclosed to form accommodating space for accommodating the PCB 15 and another component.

The display 12 may include a liquid crystal display (liquid crystal display, LCD) panel, a light-emitting diode (light-emitting diode, LED) display panel, an organic light-emitting diode (organic light-emitting diode, OLED) display panel, or the like. This is not limited in this application.

The cover 14 may be tightly attached to the display 12, and may be mainly used to protect the display 12 for dust resistance. The cover 14 may be a cover glass (cover glass), or may be replaced with a cover of another material, for example, a cover of an ultra-thin glass material or a cover of a PET (Polyethylene terephthalate, polyethylene terephthalate) material. The rear cover 13 may be a rear cover made of a metal material, or may be a rear cover made of a non-conductive material, for example, a glass rear cover, a plastic rear cover, or another non-metallic rear cover.

The middle frame 11 is mainly used to support the electronic device. The PCB 15 may be disposed between the middle frame 11 and the rear cover 13, or the PCB 15 may be disposed between the middle frame 11 and the display 12. The PCB 15 may be a flame-resistant material

(FR-4) dielectric board, or may be a Rogers (Rogers) dielectric board, or may be a hybrid dielectric board of Rogers and FR-4, or the like. Herein, FR-4 is a grade designation for a flame-resistant material, and the Rogers dielectric board is a high-frequency board. A plurality of electronic elements, for example, a radio frequency chip, may be carried on the PCB 15.

In an embodiment, a metal layer may be disposed on the PCB 15. The metal layer may be used to ground the electronic element carried on the PCB 15, or may be used to ground another element, for example, a bracketed antenna or a frame antenna. The metal layer may be referred to as a ground, a ground plate, or a ground layer. In an embodiment, the metal layer may be formed by etching metal on a surface of any dielectric board in the PCB 15. In an embodiment, the metal layer used for grounding may be disposed on a side that is of the PCB 15 and that is close to the middle frame 11. In an embodiment, an edge of the PCB 15 may be considered as an edge of a ground layer of the PCB 15. In an embodiment, the metal middle frame 11 may also be configured to ground the foregoing element. The electronic device 100 may further have another ground/ground plate/ground layer. Details are not described herein again.

The electronic device 100 may further include a battery (not shown in the figure). The battery may be disposed between the middle frame 11 and the rear cover 13, or may be disposed between the middle frame 11 and the display 12. In some embodiments, the PCB 15 may be divided into a mainboard and a sub-board. A battery may be disposed between the mainboard and the sub-board. The mainboard may be disposed between the middle frame 11 and an upper edge of the battery, and the sub-board may be disposed between the middle frame 11 and a lower edge of the battery.

The electronic device 100 may further include a side frame 16, and the side frame 16 may be made of a conductive material like metal. The side frame 16 may be disposed between the display 12 and the rear cover 13, and extend around a periphery of the electronic device 100. The side frame 16 may have four sides surrounding the display 12, to help fasten the display 12. In an implementation, the side frame 16 made of a metal material may be directly used as a metal frame of the electronic device 100 to form an appearance of the metal frame, and is applicable to a metal industrial design (industrial design, ID). In another implementation, an outer surface of the side frame 16 may alternatively be made of a non-metal material, for example, is a plastic frame, to form an appearance of the non-metal frame, and is applicable to a non-metal ID.

The middle frame 11 may include the side frame 16, and the middle frame 11 including the side frame 16 is used as an integrated component, and may support an electronic component in the electronic device. The cover 14 and the rear cover 13 respectively fit upper edges and lower edges of the side frame, to enclose a casing or a housing (housing) of the electronic device. In an embodiment, the cover 14, the rear cover 13, the side frame 16, and/or the middle frame 11 may be collectively referred to as a casing or a housing of the electronic device 100. It should be understood that the “casing or housing” may be used to refer to a part or all of any one of the cover 14, the rear cover 13, the side frame 16, or the middle frame 11, or refer to a part or all of any combination of the cover 14, the rear cover 13, the side frame 16, or the middle frame 11.

Alternatively, the side frame 16 may not be considered as a part of the middle frame 11. In an embodiment, the side frame 16 and the middle frame 11 may be connected and integrally formed. In another embodiment, the side frame 16 may include a protruding part extending inwards, to be connected to the middle frame 11 by welding, using a spring or a screw, or the like. The protruding part of the side frame 16 may be further configured to receive a feed signal, so that at least a part of the side frame 16 is used as a radiator of the antenna to receive/transmit a radio frequency signal. A gap 42 may exist between the frame part that serves as the radiator and the middle frame 11, to ensure that the radiator of the antenna has a good radiation environment, and that the antenna has a good signal transmission function.

The rear cover 13 may be a rear cover made of a metal material, or may be a rear cover made of a non-conductive material, for example, a glass rear cover, a plastic rear cover, or another non-metallic rear cover.

The antenna of the electronic device 100 may be disposed in the side frame 16. When the side frame 16 of the electronic device 100 is made of a non-conductive material, the radiator of the antenna may be located in the electronic device 100 and is disposed along the side frame 16. For example, the radiator of the antenna is disposed close to the side frame 16, to reduce a volume occupied by the radiator of the antenna as much as possible, and is closer to the outside of the electronic device 100, to implement better signal transmission effect. It should be noted that, that the radiator of the antenna is disposed close to the side frame 16 means that the radiator of the antenna may be tightly attached to the side frame 16, or may be disposed close to the side frame 16. For example, there may be a specific small gap between the radiator of the antenna and the side frame 16.

The antenna of the electronic device 100, for example, a bracketed antenna or a millimeter-wave antenna, may be alternatively disposed in the housing. Clearance of the antenna disposed in the casing may be obtained by using a slit/opening on any one of the middle frame, and/or the side frame, and/or the rear cover, and/or the display, or may be obtained by using a non-conductive gap/aperture formed between any several of the middle frame, and/or the side frame, and/or the rear cover, and/or the display. The clearance of the antenna may ensure radiation performance of the antenna. It should be understood that the clearance of the antenna may be a non-conductive region formed by any conductive component in the electronic device 100, and the antenna radiates a signal to external space through the non-conductive region. In an embodiment, a form of the antenna may be an antenna form based on a flexible mainboard (Flexible Printed Circuit, FPC), an antenna form based on laser-direct-structuring (Laser-Direct-structuring, LDS), or an antenna form like a microstrip antenna

(Microstrip Disk Antenna, MDA). In an embodiment, the antenna may alternatively use a transparent structure embedded into the screen of the electronic device 100, so that the antenna is a transparent antenna element embedded into the screen of the electronic device 100.

FIG. 1 and FIG. 2 show only an example of some components included in the electronic device 100. Actual shapes, actual sizes, and actual structures of these components are not limited to those in FIG. 1.

In addition, for ease of description, in this application, a surface on which the display of the electronic device is located may be defined as a front (Front, +Z) surface, a surface on which the rear cover is located may be defined as a back (Back,−Z) surface, and a surface on which the frame is located may be defined as a side surface. When a user holds (the user usually holds the electronic device vertically and faces a screen) the electronic device, a position in which the electronic device is located includes a top (Top, +Y), a bottom (Bottom,−Y), a left side part (Left,−X), and a right side part (Right, +X).

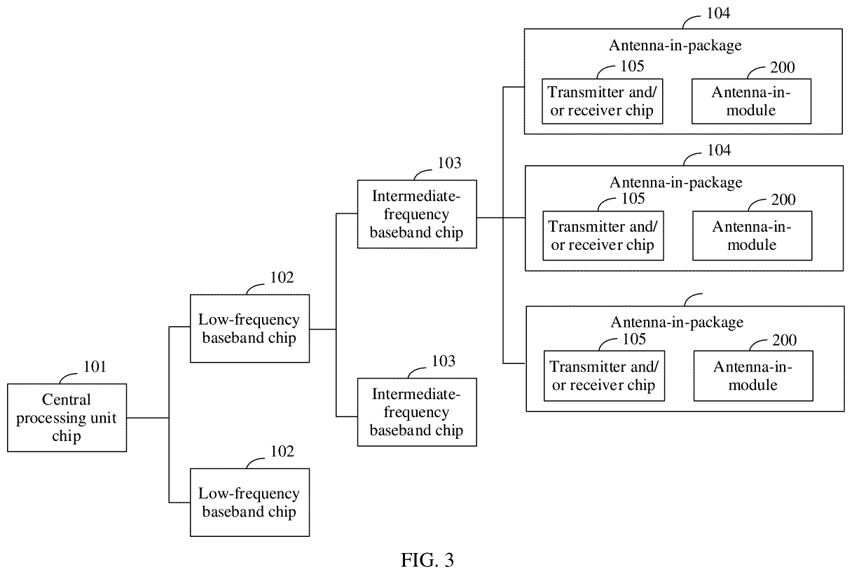

FIG. 3 is an architecture of a communication system of an electronic device according to an embodiment of this application. Refer to FIG. 3. The electronic device 100 further includes a central processing unit (central processing unit, CPU) chip 101, a low-frequency baseband chip 102, an intermediate-frequency baseband chip 103, and an antenna-in-package (antenna-in-package, AIP) (also referred to as a substrate antenna) 104.

The antenna-in-package 104 may include a transmitter and/or receiver (transmitter and/or receiver, T/R) chip 105 and an antenna-in-module (antenna-in-module) 200, and the transmitter and/or receiver chip 105 is electrically connected to the antenna-in-module 200. The transmitter and/or receiver chip 105 is configured to transmit and/or receive an electromagnetic wave signal to and/or from the antenna-in-module 200. The antenna-in-module 200 is configured to radiate an electromagnetic wave based on the received electromagnetic signal, and/or send an electromagnetic signal to the transmitter and/or receiver chip 105 based on the received electromagnetic wave, to implement wireless communication of the electronic device 100. The transmitter and/or receiver chip 105 may be a millimeter wave (millimeter wave, mmW) transmitter and/or receive chip. In this case, the electronic device 100 is a mobile phone having a millimeter wave function, and the electronic device 100 may operate in a millimeter-wave frequency band. In some other embodiments, the transmitter and/or receiver chip 105 may alternatively be another radio frequency module (radio frequency module, AF module) that can transmit and/or receive a radio frequency signal.

The low-frequency baseband chip 102 and the intermediate-frequency baseband chip 103 may be, for example, digital operation chips, and a millimeter-wave chip may be, for example, a digital-analog conversion chip. Because the millimeter-wave chip has a high operation frequency (>20 GHz), a radio frequency link has a large insertion loss. Therefore, after receiving and/or transmitting a millimeter-wave signal, the millimeter-wave chip may perform frequency reduction by using the intermediate-frequency baseband chip 103, so that an intermediate-frequency signal (5 GHz to 11 GHz) with a low insertion loss is returned to the low-frequency baseband chip 102 (<2 GHz) for digital operation.

In an embodiment, the intermediate-frequency baseband chip 103 and the antenna-in-module 200 may be integrated in a same module, to form a millimeter-wave module. In an embodiment, the low-frequency baseband chip 102 and the intermediate-frequency baseband chip 103 may be integrated into a same chip, for example, may be integrated into a millimeter-wave module. In an embodiment, the low-frequency baseband chip 102 and the intermediate-frequency baseband chip 103 may be integrated into a same chip, and may be integrated into a radio frequency chip of the CPU chip 101. A process implementation form of the CPU chip 101, the low-frequency baseband chip 102, the intermediate-frequency baseband chip 103, the antenna-in-package 104, and the like is not specifically limited in embodiments of this application. The antenna-in-package 104 is applicable to another frequency band in addition to the millimeter-wave module. This is not limited in embodiments of this application.

The central processing unit chip 101, the low-frequency baseband chip 102, the intermediate-frequency baseband chip 103, and the antenna-in-package 104 may all be installed on the PCB 15. Alternatively, the central processing unit chip 101 may be installed on the PCB 15, and the low-frequency baseband chip 102, the intermediate-frequency baseband chip 103, and the antenna-in-package 104 may be installed on a connection board (not shown in the figure). The connection plate is electrically connected to the PCB 15, and the connection plate may be a rigid circuit board or a flexible circuit board.

There may be two low-frequency baseband chips 102, and the two low-frequency baseband chips 102 may be both electrically connected to the central processing unit chip 101. There may be two intermediate-frequency baseband chips 103, and the two intermediate-frequency baseband chips 103 may be both electrically connected to one low-frequency baseband chip 102. There may be three antennas-in-package 104, and all the three antennas-in-package 104 may be electrically connected to one intermediate-frequency baseband chip 103.

In some other embodiments, there may be one or three or more low-frequency baseband chips 102, and/or there may be one or three or more intermediate-frequency baseband chips 103, and/or there may be one or three or more antennas-in-package 104, and/or the low-frequency baseband chip 102 and the intermediate-frequency baseband chip 103 are integrated into one chip. It should be noted that in embodiments of this application, “A and/or B” includes three cases: “A”, “B”, and “A and B”. Related descriptions in the following may be understood in a same way.

In some other embodiments, the antenna-in-module 200 may be separately disposed, and does not form an antenna-in-package 104 with the transmitter and/or receiver chip 105. In this case, the antenna-in-module 200 may be connected to the radio frequency chip by using a signal cable, a flexible circuit board, or the like, to implement receiving and transmitting of an electromagnetic wave signal.

An embodiment of this application provides an antenna-in-module, to reuse and co-structure (co-structure) some structures of a broadside antenna (broadside antenna, BR Antenna) and an end-fire antenna (end-fire antenna, EF Antenna), so that a radiation pattern of the antenna-in-module may be a pattern along the broadside BR or a pattern along the end-fire EF. In an embodiment of this application, the antenna-in-module may support dual-polarization (Dual-polarization) in the pattern along the broadside BR and/or the pattern along the end-fire EF.

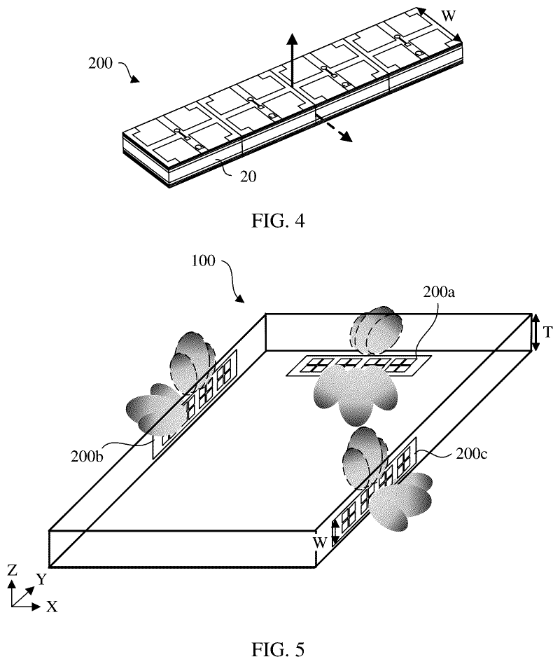

FIG. 4 is a schematic diagram of a packaging structure of an antenna-in-module according to an embodiment of this application. Refer to FIG. 4. An antenna-in-module 200 may include a substrate 20 and a plurality of antennas-in-module disposed on the substrate 20. For example, four antenna elements in the figure may be linearly arranged into a 1*4 structure.

The antenna-in-module 200 may be packaged by using a flexible soft-board process like a liquid crystal polymer (liquid crystal polymer, LCP) or modified polyimide (modified PI), or may be formed by using a hard-board process like a multi-layer laminated (laminated) circuit board, or may be formed by using a packaging process like fan-out wafer level package (fan-out wafer level package) or low temperature co-fired ceramic (low temperature co-fired ceramic, LTCC).

For example, the substrate 20 may be a multi-layer printed circuit board, and each antenna element may include a broadside antenna and an end-fire antenna. At least a part of the broadside antenna and the end-fire antenna may be embedded into the substrate 20. The broadside antenna and the end-fire antenna may share some radiators and be formed under a same process with the substrate 20, to simplify a forming process of the antenna-in-module 200.

It should be understood that a main radiation direction of the broadside antenna is a first radiation direction, a main radiation direction of the end-fire antenna is a second radiation direction, and the first radiation direction is different from the second radiation direction. For example, the first radiation direction may be a direction (as shown by a solid line arrow in the figure) perpendicular to the substrate 20, and the second radiation direction may be a direction (as shown by a dashed line arrow in the figure) parallel to the substrate 20. For example, the first radiation direction may be a thickness direction (as shown by a solid line arrow in the figure) of the substrate 20, and the second radiation direction (as shown by a dashed line arrow in the figure) may be a width direction of the substrate 20.

It should be noted that, qualifiers related to a relative position relationship, such as being parallel and perpendicular, mentioned in embodiments of this application are all for a current process level, but are not absolute and strict definitions in a mathematical sense. A small deviation is allowed, so that being approximately parallel and approximately perpendicular are acceptable. For example, in an embodiment, that A and B are parallel to each other means that A and B are parallel or approximately parallel to each other. In an embodiment, that A and B are parallel to each other means that an included angle between A and B is between 0 degrees and 10 degrees. In an embodiment, that A and B are perpendicular to each other means that A and B are perpendicular or approximately perpendicular to each other. In an embodiment, that A and B are perpendicular to each other means that an included angle between A and B is between 80 degrees and 100 degrees.

FIG. 5 is a schematic diagram of a layout of an antenna-in-module in an electronic device according to an embodiment of this application. Refer to FIG. 5. In this implementation, three antennas-in-module 200a, 200b, and 200c may be disposed in the electronic device 100, and each antenna-in-module 200 may include four antenna elements.

In an implementation, the antenna-in-module 200a may be disposed on a back side of the electronic device 100 (the substrate is parallel to the back side of the electronic device 100), and is close to the top of the electronic device 100. For example, a distance between the antenna-in-module 200a and an upper edge of the top of the middle frame does not exceed a first threshold, and the first threshold may be, for example, less than 10 mm. The antenna-in-module 200b may be disposed on a left side part of the electronic device 100 (the substrate is parallel to a side wall of the electronic device), for example, embedded into a left side wall of the middle frame, or a distance between the antenna-in-module 200b and a left edge of the left wall does not exceed a second threshold, and the second threshold may be, for example, 0.2 mm to 1 mm. The antenna-in-module 200c may be disposed on a right side part of the electronic device 100 (the substrate is parallel to a side wall of the electronic device), for example, is embedded into a right side wall of the middle frame, or a distance between the antenna-in-module 200c and a right edge of the right side wall does not exceed the second threshold, and the second threshold may be, for example, 0.2 mm to 1 mm.

The antenna-in-module 200a, the antenna-in-module 200b, and the antenna-in-module 200c are configured around the electronic device, and are separately configured to transmit/receive millimeter wave signals in different directions. The three antennas-in-module are respectively placed on the top, the left side part, and the right side part, and each antenna-in-module can perform independent beam forming (Beam forming) and beam scanning (Beam Scanning), so that a large radiation coverage range can be achieved. In addition, the antenna-in-module is placed on a side edge of the electronic device or at a position close to the side edge, so that space of the electronic device can be effectively used, and space occupied by a circuit board and another existing electronic component inside the electronic device is reduced.

In addition, it should be understood that a quantity of antennas-in-module 200 in the electronic device 100 is not specifically limited, for example, may be more than three. When three antennas-in-module 200 are disposed in the electronic device 100, positions of the three antennas-in-module 200 are not specifically limited, and may not be limited to those shown in the figure. The antenna-in-module 200 may be fixedly connected to any position on the PCB 15 in the electronic device 100, or the antenna-in-module 200 may be integrated with the PCB 15. In this case, a part of the PCB 15 forms the antenna-in-module 200, or the substrate 20 of the antenna-in-module 200 is a part of the PCB 15. The antenna-in-module 200 may be packaged on the PCB 15, or the substrate 20 of the antenna-in-module 200 is distributed inside the electronic device 100, is located on an inner side of the middle frame 11, and is electrically connected to the PCB 15.

It should be understood that, in FIG. 5, an elliptical radiation beam located near the antenna-in-module may represent a radiation gain of an antenna, where an ellipse having a dashed-line outer profile represents a radiation gain of an end-fire antenna, and an ellipse having no dashed-line outer profile represents a radiation gain of a broadside antenna. When a maximum radiation gain direction of the broadside antenna of the antenna-in-module 200a is Back (-Z), in an embodiment, the broadside antenna of the antenna-in-module 200a may perform beam scanning (Beam Scanning) on a ZX plane. When a maximum radiation gain direction of an end-fire antenna of the antenna-in-module 200a is Top (+Y), in an embodiment, the end-fire antenna of the antenna-in-module 200a may perform beam scanning on an XY plane. When a maximum radiation gain direction of the broadside antenna of the antenna-in-module 200b is Left (-X), in an embodiment, the broadside antenna of the antenna-in-module 200b may perform beam scanning on the XY plane. When a maximum radiation gain direction of the end-fire antenna of the antenna-in-module 200b is Front (+Z), in an embodiment, the end-fire antenna of the antenna-in-module 200b may perform beam scanning on a YZ plane. When a maximum radiation gain direction of the broadside antenna of the antenna-in-module 200c is Right (+X), in an embodiment, the broadside antenna of the antenna-in-module 200c may perform beam scanning on the XY plane. When a maximum radiation gain direction of the end-fire antenna of the antenna-in-module 200c is Front (+Z), in an embodiment, the end-fire antenna of the antenna-in-module 200c may perform beam scanning on the YZ plane.

In a use process, the electronic device may operate, based on a received signal, different quantities of antennas-in-module 200 at different positions, so that the antenna-in-module performs beam scanning, and/or switches between a broadside mode and an end-fire mode, to obtain an optimal signal.

It can be learned that, in the electronic device provided in this embodiment of this application, because each antenna-in-module has a broadside antenna and an end-fire antenna, three antennas-in-module are disposed, and main radiation directions of the three antennas-in-module may implement radiation coverage in five directions: Right (+X), Left (-X), Back (-Z), Front (+Z), and Top (+Y). It is not difficult to understand that when the three antennas-in-module in the electronic device are arranged at other positions, radiation coverage in more directions (for example, six directions) can be implemented. In the conventional technology, if three antennas-in-module are disposed in the electronic device, each antenna-in-module may be a broadside antenna or an end-fire antenna, and a main radiation direction of the antenna-in-module may implement radiation coverage in a maximum of three directions. Therefore, according to the electronic device provided in this embodiment of this application, a radiation coverage area can be increased, and an antenna gain can be improved.

In addition, it should be noted that, to place the antenna-in-module 200 on a side edge of the electronic device 100, a width W of the antenna-in-module 200 is limited by a side edge width (a thickness) T of the electronic device 100. As the electronic device 100 becomes lighter and thinner, T may be less than 8 mm or 6 mm (or even smaller). It is assumed that the broadside antenna and the end-fire antenna in the conventional technology are directly integrated into a same antenna-in-module. In this case, it is estimated that a width of the antenna-in-module is not less than 5.5 mm, and the antenna-in-module cannot be placed on a side edge of the electronic device 100 as 200b and 200c in FIG. 5, and can only occupy an area of the PCB 15 in the electronic device 100 in a plane. This is significantly unfavorable to arrangement of internal space of the electronic device.

To resolve this problem, an embodiment of this application provides an antenna-in-module. When a broadside antenna and an end-fire antenna are integrated into one antenna-in-module, some structures of the broadside antenna and the end-fire antenna are reused and co-structured, so that compared with the conventional technology in which the broadside antenna and the end-fire antenna are directly placed together, a manner in which some structures of the broadside antenna and the end-fire antenna are reused and co-structured can greatly reduce an overall use area of the antenna-in-module.

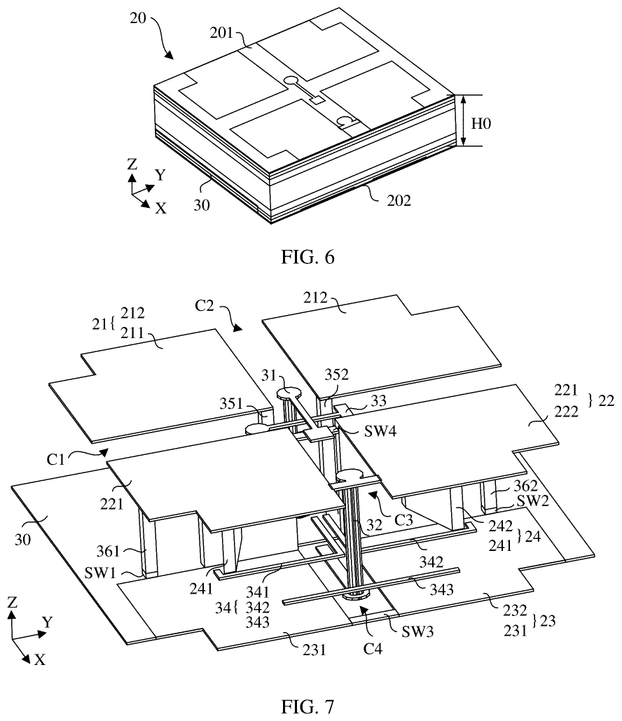

FIG. 6 is a schematic diagram of a packaging structure of an antenna element of an antenna-in-module according to an embodiment of this application. As shown in FIG. 6, the substrate 20 may include a top surface 201 and a bottom surface 202. The top surface 201 and the bottom surface 202 are disposed away from each other and may be parallel to each other. A metal layer and a ground plate 30 may be disposed inside the substrate 20. The ground plate 30 may be located between the top surface 201 and the bottom surface 202. The ground plate 30 may be disposed in parallel with the top surface 201 and the bottom surface 202. For example, the ground plate 30 may be disposed on a side close to the bottom surface 202.

In an embodiment, the top surface 201, the bottom surface 202, and the ground plate 30 may all be parallel to the XY plane. A plurality of metal layers and a plurality of insulation layers may be disposed in the substrate 20. The plurality of metal layers and the plurality of insulation layers may be arranged/stacked at intervals in a Z-axis direction. Some metal layers may be connected and conducted through a conductive connection hole, a metal post, or the like. The metal structure in the substrate 20 may be used as a radiating element, a feed stub, or a grounding element in the antenna-in-module 200.

For example, a thickness of the substrate 20 may be between 1 mm and 1.5 mm, for example, may be 1.09 mm.

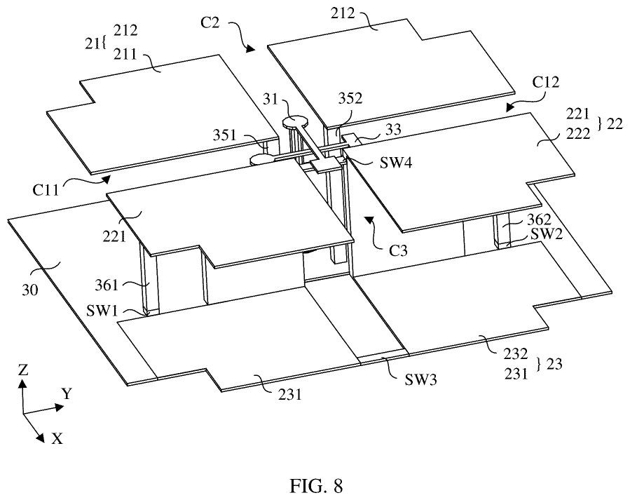

FIG. 7 is a schematic diagram of a structure of an antenna element of an antenna-in-module according to an embodiment of this application. As shown in FIG. 7, the antenna-in-module 200 provided in this embodiment of this application may include a ground plate 30, a first radiating element 21, a second radiating element 22, a third radiating element 23, a first feed stub 31, and a second feed stub 32. The first radiating element 21 and the ground plate 30 may be arranged at an interval along a Z-axis and are disposed opposite to each other. The first radiating element 21 and the second radiating element 22 may be arranged at an interval along an X-axis. A first gap C1 between the first radiating element 21 and the second radiating element 22 may extend along a Y-axis. The third radiating element 23 and the second radiating element 22 may be arranged at an interval along a Z-axis and are disposed opposite to each other. The first radiating element 21, the second radiating element 22, and the third radiating element 23 may be separately in a coupling connection to the ground plate 30.

The antenna-in-module 200 provided in this embodiment of this application may further include a fourth radiating element 24. The fourth radiating element 24 may be disposed between the second radiating element 22 and the third radiating element 23, and the fourth radiating element 24 may be in a coupling connection to the ground plate 30.

It should be understood that the X-axis, the Y-axis, and the Z-axis in this embodiment of this application are perpendicular to each other.

It should be understood that qualifiers related to a relative position relationship, such as “being arranged along an X-axis” and “extending along a Y-axis”, mentioned in embodiments of this application are not absolute and strict definitions in a mathematical sense. A small deviation is allowed, for example, may mean that being arranged in a direction approximate to the X-axis and extending in a direction approximate to the Y-axis are allowed. The approximation herein may be, for example, that a deviation angle is less than 10 degrees.

It should be understood that, in this embodiment of this application, “A and B are arranged at an interval along an X-axis” may be understood as follows: After A and B are separately equivalent to a centrosymmetric pattern like a square or a circle, respective equivalent center points of A and B are arranged at an interval along the X-axis. In other words, a connection line between the equivalent center points of A and B is located on the X-axis and the equivalent center points of A and B are spaced by a specific distance.

It should be understood that, in this embodiment of this application, the “gap” may be equivalent to a “narrow and long gap”, and the “gap extending along a Y-axis” may be understood as that a length direction of the “narrow and long gap” is a Y-axis direction. A shape of the “gap” is not required herein. A width of the “gap” may be even or approximately even, and an edge of the “gap” may be, for example, a straight line or an irregular curve.

In an embodiment, the first radiating element 21 may include a first radiator 211 and a second radiator 212 that are arranged at an interval along the Y-axis, and a second gap C2 between the first radiator 211 and the second radiator 212 may extend along the X-axis. In an embodiment, the second radiating element 22 may include a third radiator 221 and a fourth radiator 222 that are arranged at an interval along the Y-axis, and a third gap C3 between the third radiator 221 and the fourth radiator 222 may extend along the X-axis. In an embodiment, the third radiating element 23 may include a fifth radiator 231 and a sixth radiator 232 that are arranged at an interval along the Y-axis, and a fourth gap C4 between the fifth radiator 231 and the sixth radiator 232 may extend along the X-axis. In an embodiment, the fourth radiating element 24 may include a seventh radiator 241 and an eighth radiator 242, the seventh radiator 241 may be disposed between the third radiator 221 and the fifth radiator 231, and the eighth radiator 242 may be disposed between the fourth radiator 222 and the sixth radiator 232.

There may be a plurality of implementations of coupling connections between the four radiating elements and the ground plate 30. In an embodiment, the antenna-in-module 200 may further include: a first grounding element 351, a second grounding element 352, a third grounding element 361, and a fourth grounding element 362.

The first grounding element 351 may be connected between the first radiator 211 and the ground plate 30, and the second grounding element 352 is connected between the second radiator 212 and the ground plate 30. In an embodiment, the third grounding element 361 may be connected between the third radiator 221 and the ground plate 30, the third grounding element 361 may be connected to an end that is of the third radiator 221 and that faces the first radiator 211, the fourth grounding element 362 may be connected between the fourth radiator 222 and the ground plate 30, and the fourth grounding element 362 may be connected to an end that is of the fourth radiator 222 and that faces the second radiator 212. In an embodiment, the seventh radiator 241 may be connected to the third grounding element 361, and the eighth radiator 242 may be connected to the fourth grounding element 362.

In an embodiment, at least a part of the first feed stub 31 may be disposed in a first aperture (not marked in the figure), and the first aperture may include space between the first gap C1 and the ground plate 30. The first feed stub 31 may be electrically connected to a feed. In an embodiment, the first feed stub 31 is configured to excite the first radiating element 21 and the second radiating element 22 to generate an electric field along the X-axis in the first aperture.

At least a part of the second feed stub 32 may be disposed in a second aperture (not marked in the figure), and the second aperture may include space between the second radiating element 22 and the third radiating element 23. The second feed stub 32 may be electrically connected to the feed. In an embodiment, the second feed stub 32 is configured to excite the second radiating element 22 and the third radiating element 23 to generate an electric field along the Z-axis in the second aperture.

In an embodiment, the antenna-in-module 200 may further include a third feed stub 33 and a fourth feed stub 34.

At least a part of the third feed stub 33 may be disposed in a third aperture (not marked in the figure), and the third aperture may include space between the second gap C2 and the third gap C3 and the ground plate 30. The third feed stub 33 may be electrically connected to the feed. In an embodiment, the third feed stub 33 is configured to: excite the first radiating element 21 and the second radiating element 22 to generate an electric field along the Y-axis in the third aperture.

The fourth feed stub 34 may include a first feed structure 341 and a second feed structure 342. The first feed structure 341 may be in a coupling connection to the seventh radiator 241, and the second feed structure 342 may be in a coupling connection to the eighth radiator 242. The first feed structure 341 and the second feed structure 342 may be electrically connected to the feed separately. In an embodiment, the fourth feed stub 34 is configured to excite the seventh radiator 241 and the eighth radiator 242 to generate an electric field along the Y-axis.

It should be understood that, in this embodiment of this application, the “aperture” is a three-dimensional spatial structure. For example, the “first aperture” not only includes the first gap C1 between the first radiating element 21 and the second radiating element 22, but also includes space that is of the first gap C1 and that faces a side of the ground plate 30, and may further include space that is of the first gap C1 and that is away from a side of the ground plate 30.

In an embodiment, the third radiating element 23 may be connected to the ground plate 30, or may be formed by using a partial structure of the ground plate 30. It should be understood that, in another embodiment, the third radiating element 23 may be disposed above or below the ground plate 30 (a positive direction of the Z-axis in the figure is the above), and is connected to the ground plate 30 by using a ground stub. In the following embodiments of this application, an embodiment in which the third radiating element 23 is used as a part of the ground plate 30 is used for description. In an embodiment, a part of a metal layer (for example, a metal layer located on an upper surface, or any metal layer used as the ground plate) of the substrate (for example, a PCB board) may be used as the third radiating element 23.

The antenna-in-module 200 provided in the embodiment shown in FIG. 7 integrates a broadside antenna and an end-fire antenna. The following better explains an operating principle of the antenna-in-module provided in this embodiment of this application by splitting the antenna-in-module into a broadside antenna and an end-fire antenna.

It should be understood that FIG. 7 completely shows four feed stubs, which are respectively feed structures used for the broadside antenna and the end-fire antenna. However, the solution included in FIG. 7 is not limited to one embodiment in which there are four feed stubs, and may further include a plurality of embodiments in which at least one feed stub is combined. For example, the broadside antenna may include the first feed stub 31 and/or the third feed stub 33. For another example, the end-fire antenna may include the second feed stub 32 and/or the fourth feed stub 34.

It should be understood that FIG. 7 completely shows a solution of vertical polarization of the broadside antenna, horizontal polarization of the broadside antenna, vertical polarization of the end-fire antenna, and horizontal polarization of the end-fire antenna. However, the solution corresponding to FIG. 7 is not limited to an embodiment of implementing both dual-polarization of the broadside antenna and dual-polarization of the end-fire antenna. In an embodiment of this application, the solution corresponding to FIG. 7 may be further split into an embodiment of implementing vertical polarization of a broadside antenna and horizontal polarization of the broadside antenna, an embodiment of implementing vertical polarization of an end-fire antenna and horizontal polarization of the end-fire antenna, an embodiment of implementing vertical polarization of a broadside antenna and vertical polarization of an end-fire antenna, an embodiment of implementing horizontal polarization of a broadside antenna horizontal polarization of an end-fire antenna, an embodiment of implementing single polarization of a broadside antenna, an embodiment of implementing single polarization of an end-fire antenna, or the like. These embodiments may be obtained based on FIG. 7 and a corresponding description of FIG. 7, and all these embodiments should fall within the scope of this application.

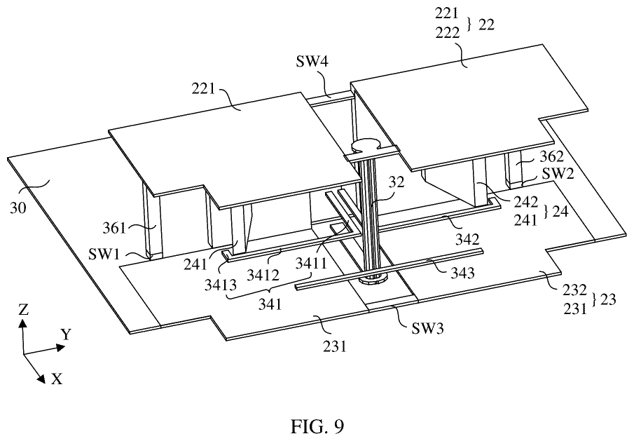

FIG. 8 provides an embodiment, obtained by splitting the embodiment of this application corresponding to FIG. 7, of a broadside antenna. FIG. 9 provides an embodiment, obtained by splitting the embodiment of this application corresponding to FIG. 7, of an end-fire antenna. It is not difficult to understand that the embodiment of the broadside antenna provided in FIG. 8 is not limited to an embodiment of implementing dual-polarization of the broadside antenna, and the embodiment of the end-fire antenna provided in FIG. 9 is not limited to an embodiment of implementing dual-polarization of the end-fire antenna.

FIG. 8 is a schematic diagram of a structure of a broadside antenna in an antenna-in-module according to an embodiment of this application. As shown in FIG. 8, the broadside antenna provided in this embodiment of this application may include the ground plate 30, the first radiating element 21, the second radiating element 22, a first grounding element 351, a second grounding element 352, a third grounding element 352, a fourth grounding element 354, the first feed stub 31, and the third feed stub 33. It should be understood that the first radiating element 21 and the second radiating element 22 are main radiators of the broadside antenna. In an embodiment, the ground plate 30 of the broadside antenna may be used to form at least a part of the third radiating element 23 in the end-fire antenna.

The broadside antenna provided in an embodiment of this application may be a magneto electric dipole (magneto electric dipole) antenna having a dual-polarization characteristic. The first feed stub 31 is configured to: excite the first radiating element 21 and the second radiating element 22 to generate an electric field along the X-axis, and excite the broadside antenna to generate vertical polarization radiation. The third feed stub 33 is configured to: excite the first radiating element 21 and the second radiating element 22 to generate an electric field along the Y-axis, and excite the broadside antenna to generate horizontal polarization radiation. It should be understood that the vertical polarization direction mentioned herein is an X-axis direction, and the horizontal polarization direction is a Y-axis direction.

In an embodiment, the first feed stub 31 may extend along the X-axis, a projection of a first end of the first feed stub 31 on an XY plane may be located within a projection of the second gap C2 on the XY plane, and a projection of a second end of the first feed stub 31 on the XY plane may be located within a projection of the third gap C3 on the XY plane. The first feed stub 31 crosses the first gap C1, and two ends of the first feed stub 31 may be respectively in a coupling connection to the first radiating element 21 and the second radiating element 22. In an embodiment, the first feed stub 31 may excite the first radiating element 21 and the second radiating element 22 to form vertical polarization radiation in the first aperture.

In an embodiment, the first gap C1 may include a first sub-gap C11 and a second sub-gap C12. The first sub-gap C11 is located between the first radiator 211 and the third radiator 221. The second sub-gap C12 is located between the second radiator 212 and the fourth radiator 222. The third feed stub 33 extends along the Y-axis. A projection of a first end of the third feed stub 33 on the XY plane is located within a projection of the first sub-gap C11 on the XY plane, and a projection of a second end of the third feed stub 33 on the XY plane is located within a projection of the second sub-gap C12 on the XY plane. The third feed stub 33 crosses a gap formed by the second gap C2 and the third gap C3, the first end of the third feed stub 33 may be in a coupling connection to the first radiator 211 and the third radiator 221, and the second end of the third feed stub 33 may be in a coupling connection to the second radiator 212 and the fourth radiator 222. In an embodiment, the third feed stub 33 may excite the first radiating element 21 and the second radiating element 22 to form horizontal polarization radiation in the third aperture.

In an embodiment, the first radiating element 21 and the second radiating element 22 may be arranged at an interval along the X-axis. In an embodiment, both the first radiating element 21 and the second radiating element 22 are metal layers, and may be disposed in a same plane, for example, both are parallel to the XY plane (a small deviation is allowed). In an embodiment, a metal layer of the substrate 20 may form the first radiating element 21 and the second radiating element 22. In an embodiment, the first radiating element 21 and the second radiating element 22 may be formed with the metal layer in the substrate 20 in a same process, to simplify a preparation process.

The first feed stub 31 may be formed by using a metal layer, and may be disposed in a same plane, for example, parallel to the XY plane. For example, a metal layer in which the first feed stub 31 is located may be coplanar with a metal layer in which the first radiating element 21 and the second radiating element 22 are located. The third feed stub 33 may be formed by using a metal layer, and may be disposed in a same plane, for example, parallel to the XY plane. For example, the third feed stub 33 and the first feed stub 31 may be disposed in different metal layers in the substrate 20.

In an embodiment, the first grounding element 351 may be connected to a corner that is of the first radiator 211 and that is close to the second radiator 212 and the third radiator 221, and the second grounding element 352 may be connected to a corner that is of the second radiator 212 and that is close to the first radiator 211 and the fourth radiator 222. Both the first grounding element 351 and the second grounding element 352 may extend along the Z-axis, and are of a conductive connection hole structure.

In an embodiment, the third grounding element 361 may be of a metal wall structure, and the metal wall may be connected to a side that is of the third radiator 221 and that is close to the first radiator 211. The fourth grounding element 362 may be of a metal wall structure, and the metal wall may be connected to a side that is of the fourth radiator 222 and that is close to the second radiator 212. The metal wall may extend along the Z-axis, and is of a conductive connection hole structure.

In an implementation, a width of the first gap C1 may be the same as a width of the second gap C2 and a width of the third gap C3. In an implementation, the first radiating element 21 and the second radiating element 22 may have a same area and shape. In an implementation, the first radiator 211, the second radiator 212, the third radiator 221, and the fourth radiator 222 may have a same area and shape, and are centrosymmetric.

Shapes of the first radiator 211, the second radiator 212, the third radiator 221, and the fourth radiator 222 are not specifically limited in embodiments of this application. Shapes of all the four radiators may be set as a rectangle, or a rectangle with a missing corner shown in the figure. In an example, the four radiators have a same size and shape, and the shape of the radiator may be set as a square having a square missing corner. A spacing between any two radiators is the same, and the four radiators as a whole form a large square having a square missing corner in a positive direction at all four corners. It should be understood that an electrical length of the radiator may be increased by adding a missing corner to the radiator. It should be understood that a missing corner/recessed part or a protruding part of any shape may be disposed at any position of the radiator, and this should not be construed as a limitation on this application.

FIG. 9 is a schematic diagram of a structure of an end-fire antenna in an antenna-in-module according to an embodiment of this application. As shown in FIG. 9, the end-fire antenna provided in this embodiment of this application may include the ground plate 30, the second radiating element 22, the third radiating element 23, the fourth radiating element 24, a third grounding element 361, a fourth grounding element 362, the second feed stub 32, and the fourth feed stub 34.

The end-fire antenna provided in an embodiment of this application may be a magneto electric dipole (magneto electric dipole) antenna having a dual-polarization characteristic. The second feed stub 32 is configured to: excite the second radiating element 22 and the third radiating element 23 to generate an electric field along the Z-axis, and excite the end-fire antenna to generate vertical polarization radiation. The fourth feed stub 34 is configured to: excite the fourth radiating element 24 to generate an electric field along the Y-axis, and excite the end-fire antenna to generate horizontal polarization radiation. It should be understood that the vertical polarization direction mentioned herein is a Z-axis direction, and the horizontal polarization direction is a Y-axis direction.

In an embodiment, the second feed stub 32 may extend along the Z-axis, and an end of the second feed stub 32 is in a coupling connection to the second radiating element 22. The second feed stub 32 crosses the second aperture, a first end of the second feed stub 32 may be in a coupling connection to the third radiating element 23, and a second end of the second feed stub 32 may be connected to the second radiating element 22. In an embodiment, the second feed stub 32 may excite the second radiating element 22 and the third radiating element 23 to form vertical polarization radiation in the second aperture.

The second feed stub 32 may be of a conductive connection hole structure in the substrate 20. The conductive connection hole structure may be of a solid metal post structure formed by filling the connection hole with a metal material, or may be a metal layer formed after a metal material partially or completely covers a hole wall of the connection hole. All conductive connection holes in this specification may be understood as such.

In an embodiment, the second radiating element 22 and the third radiating element 23 may be two metal layers in different planes, for example, may be disposed in parallel and opposite to each other. In an embodiment, both the second radiating element 22 and the third radiating element 23 may be parallel to the XY plane (a small deviation is allowed).

In an implementation, the second radiating element 22 and the third radiating element 23 have a same area and shape. In an embodiment, the second radiating element 22 and the third radiating element 23 are disposed opposite to each other. For example, an orthographic projection of the third radiating element 23 on the second radiating element 22 completely covers the second radiating element 22. In some other implementations, the second radiating element 22 and the third radiating element 23 may alternatively have different areas and/or shapes. In some other implementations, the second radiating element 22 and the third radiating element 23 may not be completely opposite to each other. For example, the second radiating element 22 and the third radiating element 23 may be partially opposite to each other.

The fourth radiating element 24 may include a seventh radiator 241 and an eighth radiator 242 that are arranged at an interval along the Y-axis. In an embodiment, both the seventh radiator 241 and the eighth radiator 242 may be disposed perpendicular to the XY plane.

In an embodiment, the seventh radiator 241 and the eighth radiator 242 have a same area and shape, and may be designed in a mirror-symmetrical manner relative to the third aperture. In an implementation, the seventh radiator 241 and the eighth radiator 242 may be disposed perpendicular to the YZ plane. For example, the seventh radiator 241 and the eighth radiator 242 may be disposed in parallel and opposite to each other. In another implementation, the seventh radiator 241 and the eighth radiator 242 may be disposed at an included angle relative to the YZ plane. For example, the seventh radiator 241 and the eighth radiator 242 may not be parallel to each other. For example, as shown in the figure, a first end of the seventh radiator 241 is connected to the third grounding element 361, a second end of the seventh radiator 241 extends toward a side away from the eighth radiator 242, a first end of the eighth radiator 242 is connected to the fourth grounding element 362, and a second end of the eighth radiator 242 extends toward a side away from the seventh radiator 241. That is, in a direction from X+to X-, from a direction away from the first radiating element 21 to a direction close to the first radiating element 21, a distance between the seventh radiator 241 and the eighth radiator 242 in the Y direction may be gradually reduced.

In an embodiment, the fourth feed stub 34 may include a first feed structure 341 and a second feed structure 342. An end part of the first feed structure 341 may be in a coupling connection to the seventh radiator 241, and an end part of the second feed structure 342 may be in a coupling connection to the eighth radiator 242. In an embodiment, the first feed structure 341 and the second feed structure 342 may carry differential signals, carry currents of a same magnitude and opposite phases, and implement excitation through non-connection capacitive coupling. In an embodiment, the fourth feed stub 34 may form horizontal polarization radiation between the seventh radiator 241 and the eighth radiator 242 through excitation.

The first feed structure 341 and the second feed structure 342 are of a metal wire structure as a whole, and may be formed by using a same metal layer in the substrate 20, to simplify a preparation process.

In the end-fire antenna provided in this embodiment of this application, a ground structure of the second radiating element 22 is the third grounding element 361 and the fourth grounding element 362. Details are not described herein again. The third radiating element 23 may be a part of the ground plate 30, and may be directly grounded. The seventh radiator 241 may be connected to the third grounding element 361, and the eighth radiator 242 may be connected to the fourth grounding element 362, to implement indirect grounding of the fourth radiating element 24.

With reference to FIG. 8 and FIG. 9, it can be learned that the second radiating element 22, the third grounding element 361, and the fourth grounding element 362 are reused and co-structured in the broadside antenna and the end-fire antenna provided in this embodiment of this application. In an embodiment, the second radiating element 22 may be used as at least a part of the radiator of each of the broadside antenna and the end-fire antenna. In an embodiment, the third grounding element 361 and the fourth grounding element 362 may be configured to be disconnected (for example, disconnected by turning off a switch) from the ground plate 30 in the broadside antenna, so that the second radiating element 22 is used as a radiator of the broadside antenna to radiate. In the end-fire antenna, the third grounding element 361 and the fourth grounding element 362 may be connected (for example, connected by turning on a switch) to the ground plate, so that the second radiating element 22 is turned on, to meet a radiation boundary condition of the end-fire antenna. In an embodiment, the broadside antenna and the end-fire antenna may further reuse the third radiating element 23. The third radiating element 23 may be used as a reference ground of the broadside antenna and also be used as a radiator of the end-fire antenna. Therefore, the antenna-in-module provided in this embodiment of this application can greatly reduce an area in which the broadside antenna and the end-fire antenna are integrated while functions of the broadside antenna and the end-fire antenna are integrated.

In addition, the antenna-in-module provided in this embodiment of this application can implement a dual-polarized broadside antenna and a dual-polarized end-fire antenna, to implement polarization diversity (polarization diversity) of the antenna-in-module 200, thereby helping improve a transmission throughput and signal stability of a weak-signal region, and meeting a signal transmission requirement.

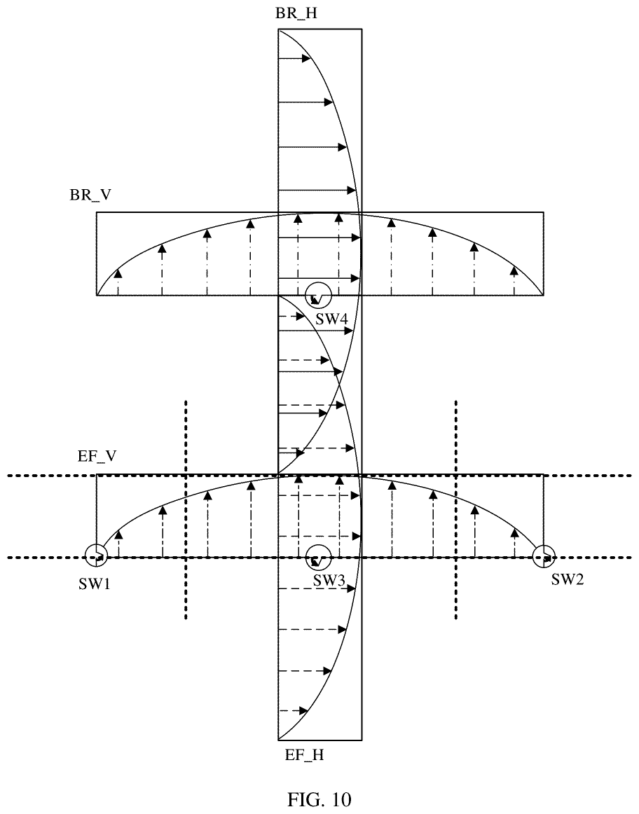

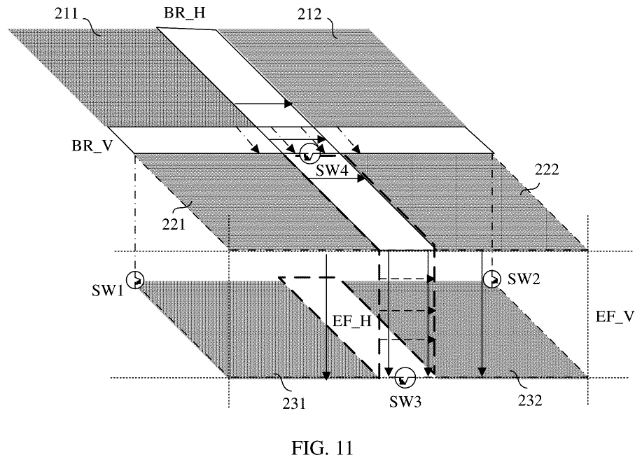

FIG. 10 is a schematic planar expanded view of an antenna-in-module according to an embodiment of this application. FIG. 11 is a topology diagram of a folded planar aperture structure of an antenna-in-module according to an embodiment of this application. It should be understood that FIG. 10 is a schematic diagram of slots between radiators obtained by spreading only the first radiating element 21, the second radiating element 22, and the third radiating element 23 into a planar structure without considering the ground plate 30, the first grounding element 35, and the second grounding element 36. The slots between the radiators are radiation apertures of the antenna-in-module 200. FIG. 11 is a schematic diagram of a three-dimensional radiation aperture structure obtained by folding a radiation aperture structure of a plane in FIG. 10 along a dashed line in FIG. 10.

BR_V refers to electric field distribution in a radiation aperture of a broadside antenna in a vertical polarization mode. BR_H refers to electric field distribution in a radiation aperture of the broadside antenna in a horizontal polarization mode. EF_V refers to electric field distribution in a radiation aperture of an end-fire antenna in the vertical polarization mode. EF_H refers to electric field distribution in a radiation aperture of the end-fire antenna in the horizontal polarization mode. It should be understood that the radiation aperture of the BR_V may be considered as the first aperture, the radiation aperture of the BR_H may be considered as the third aperture, the radiation aperture of the EF_V may be considered as the second aperture, and the radiation aperture of the EF_H may be considered as space between the third gap C3 and the fourth gap C4. It should be noted that the radiation aperture corresponding to BR_H overlaps with that corresponding to EF_H.

As shown in FIG. 10 and FIG. 11, electric fields between BR_V and BR_H are orthogonal, so that the dual-polarized broadside antenna is highly isolated and can be operated simultaneously. Similarly, electric fields between EF_V and EF_H are orthogonal, so that the dual-polarized end-fire antenna is highly isolated and can be operated simultaneously.

It should be noted that the antenna-in-module provided in this embodiment of this application reuses the second radiating element in the broadside antenna and the second radiating element in the end-fire antenna, to implement an antenna radiation pattern re-configurable (Antenna Pattern Re-configurable) through circuit control, so that the radiation pattern of the antenna-in-module may be a pattern in a broadside direction or a pattern in an end-fire direction. The circuit control may be implemented by additionally disposing a switch in the antenna-in-module 200.

With reference to FIG. 7 to FIG. 9, a first switch SW1 and a second switch SW2 may be disposed in the antenna-in-module 200, and the first switch SW1 may be connected between the third grounding element 361 and the ground plate 30. In an embodiment, the first switch SW1 is located on a side that is of the third grounding element 361 and that is away from the fourth radiator 222. The second switch SW2 may be connected between the fourth grounding element 362 and the ground plate 30. In an embodiment, the second switch SW2 is located on a side that is of the fourth grounding element 362 and that is away from the third radiator 221.

The first switch SW1 is configured to control whether to ground the third radiator 221, the second switch SW2 is configured to control whether to ground the fourth radiator 222, and the first switch SW1 and the second switch SW2 are configured to control whether to ground the second radiating element 22.

When the antenna-in-module 200 is in an end-fire mode, to forcibly meet a minimum electric field boundary condition of the EF_V, the first switch SW1 and the second switch SW2 are controlled to be turned on (turned on), so that the second radiating element 22 is grounded, to create a boundary condition in which electric fields on both sides in the radiation aperture of the EF_V are the smallest. When the antenna-in-module 200 is in a broadside mode, the first switch SW1 and the second switch SW2 are controlled to be turned off (turned off), so that a main radiation aperture of the antenna-in-module 200 returns to the radiation aperture of the BR_V and the radiation aperture of the BR_H.

With reference to FIG. 7 to FIG. 9, a third switch SW3 and a fourth switch SW4 may be further disposed in the antenna-in-module 200. The third switch SW3 may be connected between the fifth radiator 231 and the sixth radiator 232. In an embodiment, the third switch SW3 is located on a side that is of the third radiating element 23 and that is away from the first radiating element 21. The fourth switch SW4 may be connected between the third radiator 221 and the fourth radiator 222. In an embodiment, the third switch SW3 is located on a side that is of the second radiating element 22 and that is close to the first radiating element 21.

The third switch SW3 is configured to control turn-on or turn-on between the fifth radiator 231 and the sixth radiator 232, and the fourth switch SW4 is configured to control turn-on or turn-on between the third radiator 221 and the fourth radiator 222.

When the antenna-in-module 200 is in a broadside mode, the third switch SW3 is controlled to be tuned on (turned on) and the fourth switch SW4 is controlled to be turned off (turned off). When the antenna-in-module 200 is in the end-fire mode, the third switch SW3 is controlled to be turned off (turned off) and the fourth switch SW4 is controlled to be turned on (turned on). In this way, pattern operations in the broadside mode and end-fire mode are achieved.

In this embodiment of this application, all the first switch SW1, the second switch SW2, the third switch SW3, and the fourth switch SW4 may be disposed, to improve a pattern switching enhancement and an operation bandwidth.

In an embodiment of this application, it should be understood that the switch usually has a parasitic resistance (Ron) while being turned on and a capacitance (Coff) while being turned off. The third switch SW3 and the fourth switch SW4 are placed in a large electric field region of an antenna mode, to load the antenna mode. In an embodiment, a capacitance of the third switch SW3 and a capacitance of the fourth switch SW4 are less than or equal to 10 fF.

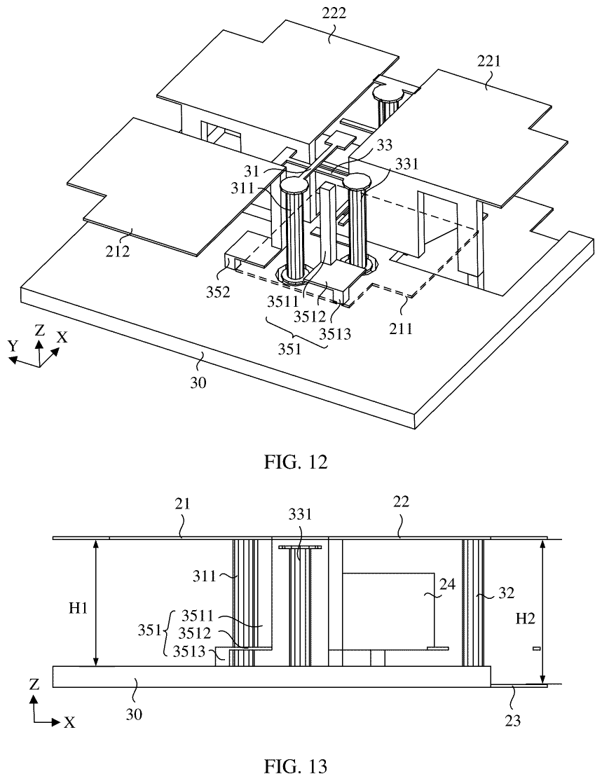

FIG. 12 is a schematic diagram of a structure of an antenna-in-module from another angle according to an embodiment of this application. To facilitate understanding of a structure blocked by the first radiator 211 in the figure, hiding processing (for example, a dashed line is used) is performed on the first radiator 211. As shown in FIG. 12, in this embodiment of this application, a first end of the first feed stub 31 is connected to a first feed-in part 311, the first feed-in part 311 may be located on a side that is of the first feed stub 31 and that faces the ground plate 30, and the first feed-in part 311 may extend along the Z-axis and be connected to a feed (not shown in the figure).

The first feed stub 31 is a vertically polarized feed stub of the broadside antenna. The first feed-in part 311 may be electrically connected to a radio frequency port of the transmitter and/or receiver chip 105, to implement a connection to the feed. The electrical connection may be implemented, for example, by using a feeder like a microstrip. The first feed stub 31 and the first feed-in part 311 may be considered as a “T” type as a whole.

A first end of the third feed stub 33 is connected to a second feed-in part 331, the second feed-in part 331 may be located on a side that is of the third feed stub 33 and that faces the ground plate 30, and the second feed-in part 331 may extend along the Z-axis and be connected to the feed.

The third feed stub 33 is a horizontally polarized feed stub of the broadside antenna. The second feed-in part 331 may be electrically connected to a radio frequency port of the transmitter and/or receiver chip 105, to implement a connection to the feed. The electrical connection may be implemented, for example, by using a feeder like a microstrip. The third feed stub 33 and the second feed-in part 331 may be considered as a “T” type as a whole.

The first feed stub 31 and the third feed stub 33 are disposed orthogonally and are insulated from each other. The first feed stub 31 and the third feed stub 33 may be disposed in different metal layers in the substrate 20. For example, the first feed stub 31 may be located in a same metal layer with the first radiator 211, the second radiator 212, the third radiator 221, and the fourth radiator 222, to simplify a preparation process. The third feed stub 33 may be located in another metal layer below (a positive direction of the Z-axis is defined as below, and a negative direction of the Z-axis is defined as above) the first feed stub 31, and an insulation layer is disposed between the two metal layers.

It should be noted that the first feed-in part 311 and the second feed-in part 331 are presented as columnar structures in the figure, to facilitate intuitive understanding of the accompanying drawings. It should be understood that, the first feed-in part 311 and the second feed-in part 331 may be of a conductive connection hole structure in the substrate 20. The conductive connection hole structure may be of a solid metal post structure formed by filling the connection hole with a metal material, or may be a metal layer formed after a metal material partially or completely covers a hole wall of the connection hole.

FIG. 13 is a side view of an antenna-in-module according to an embodiment of this application. As shown in FIG. 12 and FIG. 13, in a possible implementation, the first grounding element 351 may include a first ground segment 3511, a second ground segment 3512, and a third ground segment 3513 that are sequentially connected. The first ground segment 3511 is connected to the first radiator 211, the third ground segment 3513 is connected to the ground plate 30, and the first ground segment 3511 and the third ground segment 3513 may extend along the Z-axis and are of a conductive connection hole structure. The second ground segment 3512 may extend along the XY plane, and is formed by using a part of the metal layer in the substrate 20. The first grounding element 351 includes three bent segments as a whole, and a total electrical length of the first grounding element 351 is 1/4). The first grounding element 351 is disposed as a multi-segment bent structure, which helps reduce a height between the first radiator 211 and the ground plate 30, thereby reducing an overall size of the antenna-in-module 200.

A position of the first grounding element 351 is not specifically limited in this application. For example, the first ground segment 3511 may be connected to a corner that is of the first radiator 211 and that is close to the second radiator 212 and the third radiator 221, and orthographic projections of the second ground segment 3512 and the third ground segment 3513 on the first radiator 211 are located inside the first radiator 211, to prevent the second ground segment 3512 and the third ground segment 3513 from interfering with the first feed-in part 311.

In addition, structures of the first grounding element 351 and the second grounding element 352 may be disposed in a mirror-symmetric manner relative to the third aperture. The structure of the second grounding element 352 may be similar to the structure of the first grounding element 351, and also includes three segments. Details are not described herein again.

It should be understood that, in another possible implementation, both the first grounding element 351 and the second grounding element 352 may be of conductive connection hole structures extending along the Z-axis, and a total electrical length of the first grounding element 351 and the second grounding element 352 meets 1/4\. In this case, refer to the implementations shown in FIG. 7 and FIG. 8, neither the first grounding element 351 nor the second grounding element 352 has a bent segment, so that a ground structure design can be simplified.

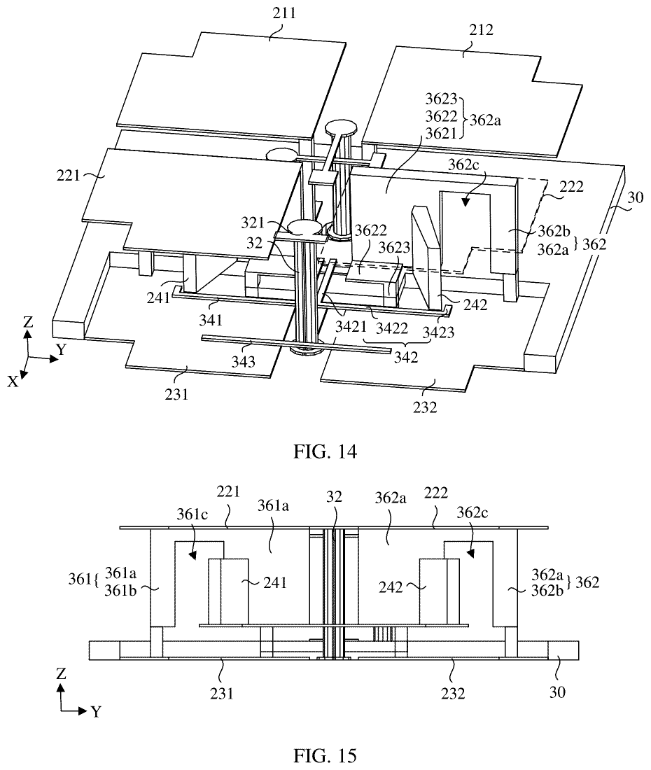

FIG. 14 is a schematic diagram of a structure of an antenna-in-module from another angle according to an embodiment of this application. To facilitate understanding of a structure blocked by the fourth radiator 222 in the figure, hiding processing (for example, a dashed line is used) is performed on the fourth radiator 222. As shown in FIG. 14, one end of the second feed stub 32 may be connected to a feed (not marked in the figure), the other end of the second feed stub 32 may be connected to a connection stub 321, and the connection stub 321 may be connected between the third radiator 221 and the fourth radiator 222. The second feed stub 32 is a vertically polarized feed stub of the end-fire antenna, and the connection stub 321 is configured to implement direct feeding of the second feed stub 32 and the second radiating element 22.

The second feed stub 32 may be of a conductive connection hole structure in the substrate 20, and the connection stub 321 may be disposed in a metal layer in the substrate 20. For example, the connection stub 321 may be located in a same metal layer with the first feed stub 31, the first radiator 211, the second radiator 212, the third radiator 221, and the fourth radiator 222, to simplify a preparation process.

With reference to FIG. 9, the first feed structure 341 may include a fourth feed-in part 3411, a first connection part 3412, and a fourth feed part 3413 that are sequentially connected. The fourth feed-in part 3411 is connected to the feed, and the fourth feed part 3413 is disposed on a side that is of the seventh radiator 241 and that is away from the eighth radiator 242. The second feed structure 342 may include a fifth feed-in part 3421, a second connection part 3422, and a fifth feed part 3423 that are sequentially connected. The fifth feed-in part 3421 is connected to the feed, and the fifth feed part 3423 is disposed on a side that is of the eighth radiator 242 and that is away from the seventh radiator 241.

The fourth feed-in part 3411, the fourth feed part 3413, the fifth feed-in part 3421, and the fifth feed part 3423 may extend along the X-axis, and the first connection part 3412 and the second connection part 3422 may extend along the Y-axis. The first feed structure 341 and the second feed structure 342 are of a metal wire structure as a whole, and may be formed by using a same metal layer in the substrate 20, to simplify a preparation process.

The fourth feed stub 34 is a horizontally polarized feed stub of the end-fire antenna, and is a coupling capacitor type excitation structure. The fourth feed stub 34 is disposed between the second radiating element 22 and the third radiating element 23, and differential signals are carried on the first feed structure 341 and the second feed structure 342 to carry currents of a same magnitude and opposite phases, to implement excitation through non-connection capacitive coupling. In this embodiment, the fourth feed stub 34 performs excitation near the fourth radiating element 24, and the fourth radiating element 24 is excited in a coupled feed-in manner, so that a loss caused by impedance mismatching can be avoided, and radiation efficiency of the end-fire antenna can be improved. It should be understood that differential characteristic impedance of the fourth feed stub 34 is adjusted by adjusting linewidths and a spacing of the first feed structure 341 and the second feed structure 342.

The fourth feed stub 34 further includes a parasitic element 343. The parasitic element 343, the first feed structure 341, and the second feed structure 342 are coplanar. The parasitic element 343 is disposed on a side that is of the first feed structure 341 and the second feed structure 342 and that is away from the seventh radiator 241 and the eighth radiator 242, -53-HW 92010130US04 Substitute Specification-Clean Copy and is disposed at an interval with the first feed structure 341 and the second feed structure 342. The parasitic element 343 extends along the Y-axis, and is parallel to and disposed at an interval with the first connection part 3412 and the second connection part 3422.

The parasitic element 343, the first feed structure 341, and the second feed structure 342 are formed by using a same metal layer in the substrate 20, to simplify a preparation process. The parasitic element 343 may strengthen a differential mode of differential currents carried on the first feed structure 341 and the second feed structure 342, and suppress a common mode of a codirectional current, to ensure that a horizontally polarized antenna mode of the end-fire antenna is excited.

FIG. 15 is a side view of an antenna-in-module from another angle according to an embodiment of this application. As shown in FIG. 14 and FIG. 15, in a possible implementation, the third grounding element 361 may include a first ground wall 361a and a second ground wall 361b. The first ground wall 361a and the second ground wall 361b are respectively connected to the third radiator 221 at a first position and a second position, and the first position and the second position are arranged at an interval on the third radiator 221. In an embodiment, the first ground wall 361a is located on a side that is of the third radiator 221 and that is close to the fourth radiator 222, the seventh radiator 241 is connected to the first ground wall 361a, and the first switch SW1 is connected between the second ground wall 361b and the ground plate 30.

The fourth grounding element 362 may include a third ground wall 362a and a fourth ground wall 362b. The third ground wall 362a and the fourth ground wall 362b are respectively connected to the fourth radiator 222 at a third position and a fourth position. The third position and the fourth position are arranged at an interval on the fourth radiator 222. In an embodiment, the third ground wall 362a is located on a side that is of the fourth radiator 222 and that is close to the third radiator 221, the eighth radiator 242 is connected to the third ground wall 362a, and the second switch SW2 is connected between the fourth ground wall 362b and the ground plate 30.

The third grounding element 361 may be in a metal wall structure having a first hollow-out region 361c, and the metal wall may be divided into the first ground wall 361a and the second ground wall 361b by the first hollow-out region 361c. A structure of the fourth grounding element 362 may be the same as a structure of the third grounding element 361. The fourth grounding element 362 may be in a metal wall structure having a second hollow-out region 362c. The metal wall may be divided into the third ground wall 362a and the fourth ground wall 362b by the second hollow-out region 362c.

The hollow-out region is used to reduce unnecessary resonance, and a size of the hollow-out region is not specifically limited in embodiments of this application. A width of the first ground wall 361a may be greater than a width of the second ground wall 361b, and the first switch SW1 may be connected to the second ground wall 361b. A width of the third ground wall 362a may be greater than a width of the fourth ground wall 362b, and the second switch SW2 may be connected to the fourth ground wall 362b.

The third ground wall 362a may include a fourth ground segment 3621, a fifth ground segment 3622, and a sixth ground segment 3623 that are sequentially connected. The fourth ground segment 3621 is connected to the fourth radiator 222, and the sixth ground segment 3623 is connected to the ground plate 30. The fourth ground segment 3621 and the sixth ground segment 3623 may extend along the Z-axis, and are of conductive connection hole structures. The fifth ground segment 3622 may extend along the XY plane, and is formed by using a part of a metal layer in the substrate 20. The third ground wall 362a includes three bent segments as a whole, and a total electrical length of the third ground wall 362a is 1/4). The third ground wall 362a is disposed as a multi-segment bent structure, which helps reduce a height between the fourth radiator 222 and the ground plate 30, thereby reducing an overall size of the antenna-in-module 200.

It should be understood that the first ground wall 361a and the third ground wall 362a may be the same in structure, and are axisymmetrically disposed relative to the third aperture. The structure of the first ground wall 361a is not described herein again.

It should be understood that, in another possible implementation, the first ground wall 361a and the third ground wall 362a may be of conductive connection hole structures extending along the Z-axis, and a total electrical length of the first ground wall 361a and the third ground wall 362a meets 1/4). In this case, refer to the implementations shown in FIG. 7 to FIG. 9, neither the first ground wall 361a nor the third ground wall 362a has a bent segment, so that a structure design can be simplified.

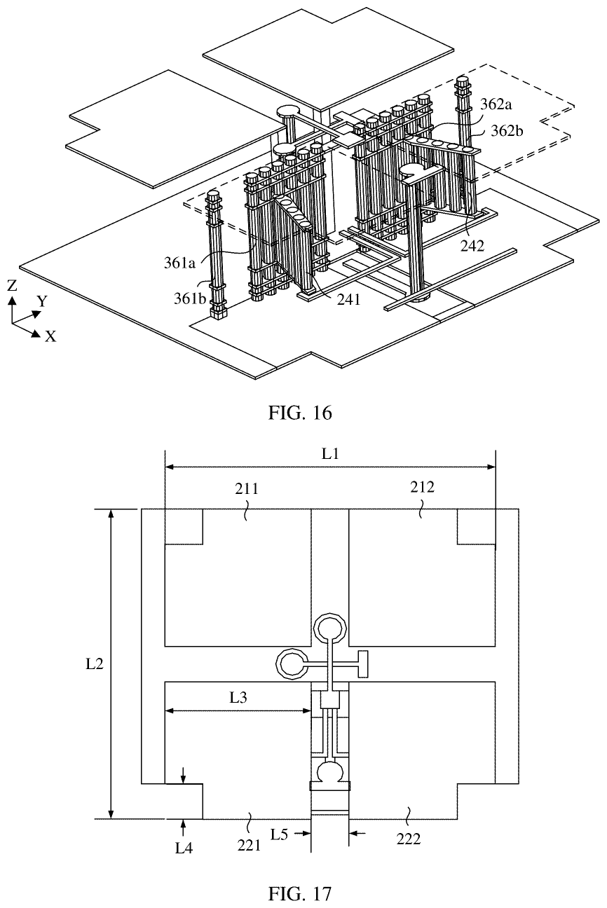

FIG. 16 is a schematic diagram of a structure of a metal wall according to an embodiment of this application. As shown in FIG. 16, in a possible implementation, the ground walls 361a, 361b, 362a, and 362b, and the radiators 241 and 242 are of a metal wall structure as a whole. The metal wall may include a plurality of conductive connection holes, and there may be intervals between the plurality of conductive connection holes. The plurality of conductive connection holes may communicate with each other by using a metal layer. Each conductive connection hole structure may be of a solid metal post structure formed by filling the connection hole with a metal material, or a metal layer formed after a metal material partially or completely covers a hole wall of the connection hole.

In another possible implementation, the metal wall structure may be a complete wall structure. The complete wall structure may be of a solid metal post structure formed after a metal material is filled into an elongated cavity, or may be a metal layer formed after a metal material partially or completely covers an inner wall of an elongated cavity.

In an embodiment, the antenna-in-module provided in embodiments of this application may support a millimeter-wave band, for example, a 5G millimeter-wave band. For a millimeter-wave antenna module applied to an electronic device like a mobile phone, a length and a width of an antenna element may be, for example, less than 4 mm, and a thickness of the antenna element may be less than 1.5 mm.

FIG. 17 is a schematic top view of an antenna-in-module according to an embodiment of this application. As shown in FIG. 17 and FIG. 13, in a specific implementation, a distance H1 between the first radiating element 21 and the ground plate 30 may be 0.9 mm, a distance H2 between the second radiating element 22 and the ground plate 30 may be 1.05 mm, a length L1 of the first radiating element 21 may be 3.5 mm, and a length L2 of the second radiating element 22 may be 3.5 mm. All the six radiating elements may be shaped like a square with a missing corner, a side length L3 of the square may be 1.55 mm, the missing corner may be shaped like a square, and a width L4 of the missing corner may be 0.4 mm. The first gap C1, the second gap C2, the third gap C3, and the fourth gap C4 may have a same width, and a width L5 of the gap may be 0.4 mm.

The foregoing antenna elements with a size of 3.5*3.5*1.05 mm3 are arranged as the antenna-in-module 200 shown in FIG. 4. The first switch SW1 and the second switch SW2 are controlled to be turned on or turned off to excite the antenna-in-module 200 with a broadside dual-polarized feed stub or an end-fire dual-polarized feed stub, to obtain a radiation gain pattern of the antenna-in-module 200.

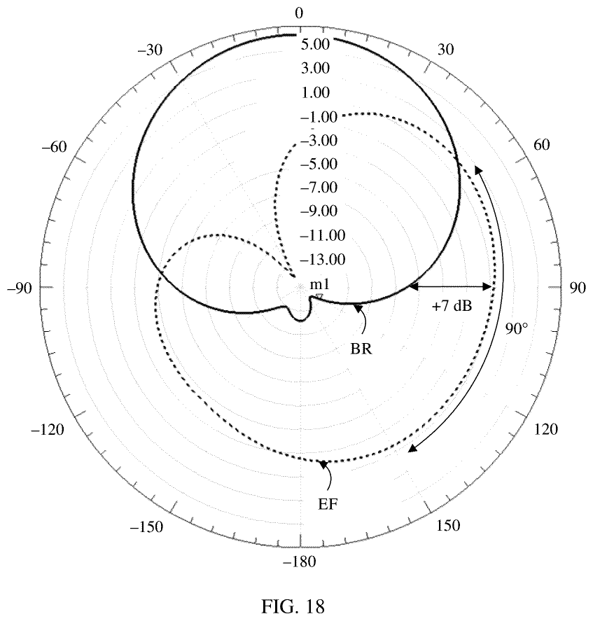

FIG. 18 is a radiation gain pattern of an antenna-in-module according to an embodiment of this application. As shown in FIG. 18, BR represents a broadside antenna, and a maximum gain is in a broadside direction (corresponding to a +Z direction in FIG. 7) in which Theta=0°. EF represents an end-fire antenna, and a maximum gain is in an end-fire direction (corresponding to a +X direction in FIG. 7) in which Theta=90°. According to the antenna-in-module provided in this embodiment of this application, the broadside antenna and the end-fire antenna are co-structured. Compared with the conventional technology in which only a broadside antenna is available, this embodiment of this application increases a coverage angle by approximately 90°, and has an antenna gain of 7 dB in the end-fire direction in which Theta=90°. It can be learned that the antenna-in-module 200 provided in this embodiment of this application can significantly increase a coverage angle and an antenna gain without increasing an antenna area by co-structuring the broadside antenna and the end-fire antenna.

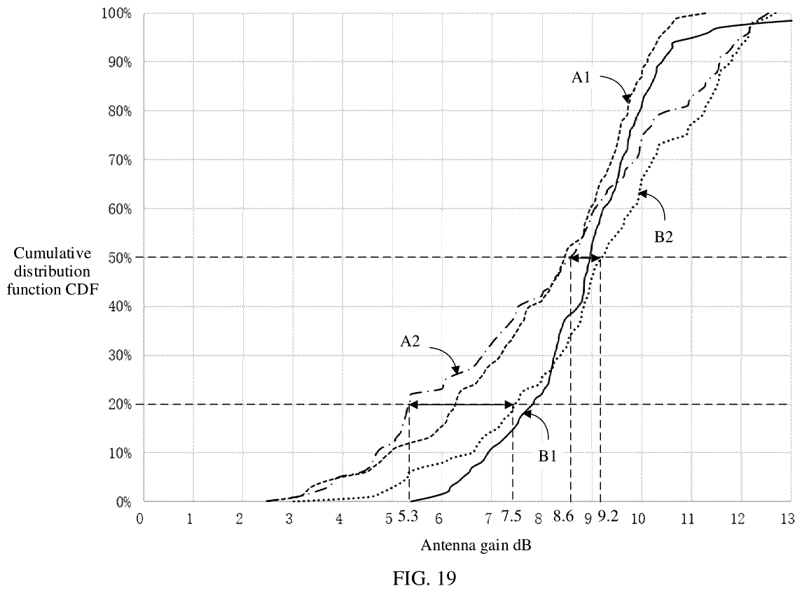

FIG. 19 is a diagram of a cumulative distribution function of an antenna gain of an antenna-in-module according to an embodiment of this application. A1 and A2 represent antenna gains of the conventional technology in which only a broadside antenna is disposed. B1 and B2 represent specific quantized antenna gains obtained after the antenna-in-module 200 is applied to the electronic device 100 and arranged based on the position in FIG. 5 in this application. A1 and B1 represent a frequency of −27 GHZ, and A2 and B2 represent a frequency of −40 GHZ. 20% CDF is an important indicator for observing weak field strength under the operator's specification, and 50% CDF is an important indicator for observing weak field strength under the 3GPP specification. As shown in FIG. 19, when a vertical coordinate is 20%, horizontal coordinates of A2 and B2 are respectively corresponding to 5.3 and 7.5, that is, at a same frequency of −40 GHz, an antenna gain of a millimeter wave of a mobile phone provided in the conventional technology is 5.3 dB, and an antenna gain of the antenna-in-module in this application is 7.5 dB, which is increased by 2.2 dB in comparison with the antenna gain of the millimeter wave. When a vertical coordinate is 50%, horizontal coordinates of A2 and B2 are respectively corresponding to 8.6 and 9.2, that is, at a same frequency of-40 GHZ, an antenna gain of a millimeter wave of a mobile phone provided in the conventional technology is 8.6 dB, and an antenna gain of the antenna-in-module in this application is 9.2 dB, which is increased by 0.6 dB in comparison with the antenna gain of the millimeter wave.

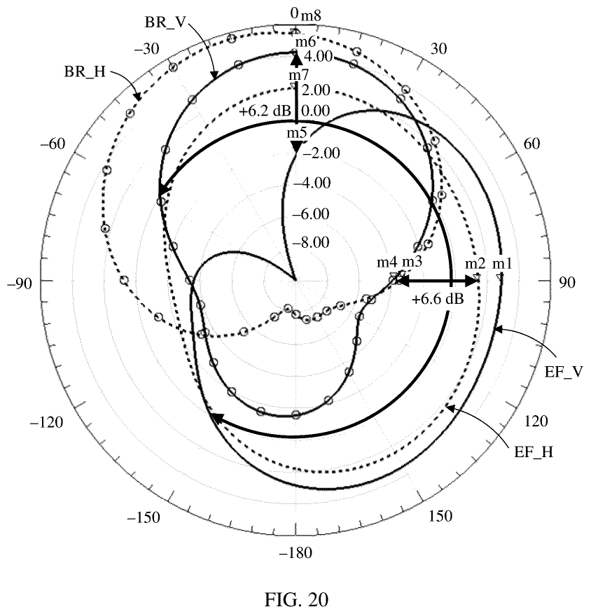

FIG. 20 is an antenna gain pattern of an antenna-in-module on a YZ plane according to an embodiment of this application, where a direction of Theta=0° represents a broadside direction, a direction of Theta=90° represents an end-fire direction, BR_V and BR_H respectively represent a vertical polarization radiation pattern and a horizontal polarization pattern in a broadside mode, and EF_V and EF_H respectively represent a vertical polarization radiation pattern and a horizontal polarization pattern in an end-fire mode. Table 1 shows antenna gain data of the antenna-in-module according to an embodiment of this application, and Table 2 shows data of an antenna coverage angle of the antenna-in-module according to an embodiment of this application.

As shown in FIG. 20, Table 1, and Table 2, vertical polarization is used as an example. When operation is performed in the broadside mode, a gain in the +Z direction may be 4.2 dB. When operation is performed in the end-fire mode, a gain in the +Z direction is only-2.0 dB. Therefore, a switching enhancement of 6.2 dB may be obtained in the +Z direction through pattern switching. Similarly, when operation is performed in the broadside mode, a gain in the +X direction is only-3.8 dB. However, if the operation is switched to the end-fire mode, a gain of 2.9 dB may be obtained. Therefore, a switching enhancement of 6.7 dB may be obtained in the +X direction through pattern switching. In addition, through observation at an angle at which the gain is greater than 0 dB, a gain coverage angle of the conventional technology in which only a broadside antenna is available is 120°. In this application, the coverage angle can be expanded to 270° by switching between the broadside mode and the end-fire mode. Therefore, compared with the conventional technology, this application has an enhancement of 150° in coverage angle.

TABLE 1

| Gain | Vertical polarization | | | Horizontal polarization | | |
|---|---|---|---|---|---|---|
| (dB) | Broadside | End-fire | | Broadside | End-fire | |
| Mode | antenna | antenna | Enhancement | antenna | antenna | Enhancement |
| +Z | +4.2 | −2.0 | 6.2 | +5.4 | +2.0 | 3.4 |
| +X | −3.8 | +2.9 | 6.7 | −3.2 | 1.5 | 4.7 |

TABLE 2

| | Vertical polarization | | | Horizontal polarization | | |
|---|---|---|---|---|---|---|
| | Broadside | Broadside + end- | | Broadside | Broadside + end- | |
| Mode | antenna | fire antenna | Enhancement | antenna | fire antenna | Enhancement |
| Gain >0 | 120 | 270 | 150 | 160 | 305 | 145 |
| dB | | | | | | |
| Coverage | | | | | | |
| angle (°) | | | | | | |

FIG. 18 to FIG. 20 show effect of the antenna-in-module 200 according to an embodiment of this application in an implementation. In this implementation, the antenna-in-module 200 is a dual-polarized pattern-switchable co-structured broadside and end-fire antenna. In this case, the antenna-in-module 200 may include four radiating elements 21 to 24, four feed stubs 31 to 34, and two switches SW1 and SW2. By switching through the switch and selecting the feed stub, the antenna-in-module may be used to implement a dual-polarized broadside radiation pattern or a dual-polarized end-fire radiation pattern.

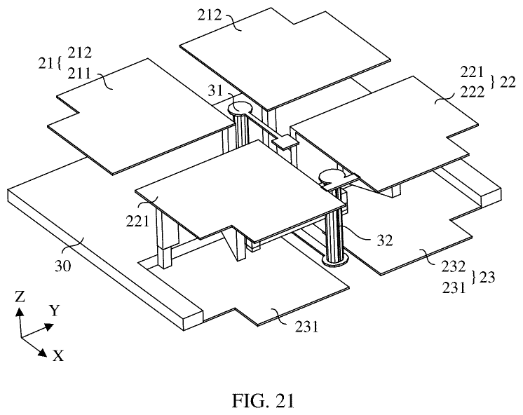

FIG. 21 is another schematic diagram of a structure of an antenna-in-module according to an embodiment of this application. As shown in FIG. 21, in some other implementations, the antenna-in-module 200 may be a vertically polarized dual-band antenna. In this case, the antenna-in-module 200 may include three radiating elements 21 to 23, the first feed stub 31, and the second feed stub 33, and include only a broadside vertically polarized antenna and an end-fire vertically polarized antenna. The broadside antenna may support both a low-frequency band and a high-frequency band, and the end-fire antenna may also support both a low-frequency band and a high-frequency band. For structures and operating principles of the broadside vertically polarized antenna and the end-fire vertically polarized antenna, refer to the description of the dual-polarized pattern-switchable co-structured broadside and end-fire antenna. Details are not described herein again.

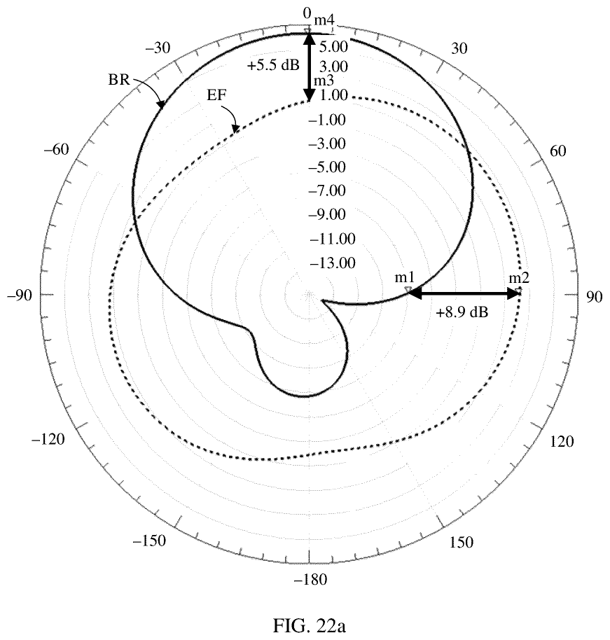

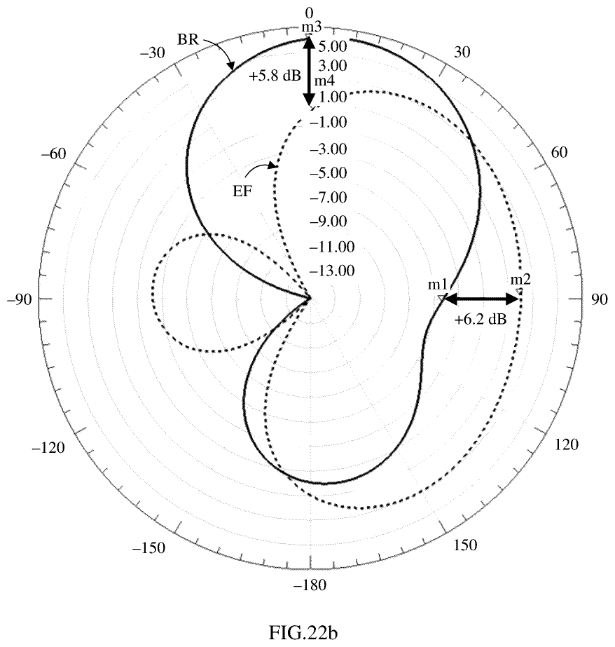

FIG. 22a is a diagram of a broadside and end-fire vertical polarization radiation gain pattern of the antenna-in-module provided in FIG. 21 in a low-frequency band, and FIG. 22b is a diagram of a broadside and end-fire vertical polarization radiation gain pattern of the antenna-in-module provided in FIG. 21 in a high-frequency band. The low-frequency band is a 29.0 GHz frequency band, and the high-frequency band is a 39.0 GHz frequency band. In the low-frequency band, in the +Z direction, compared with an operation in a broadside mode, an operation in an end-fire mode may have a switching enhancement of 5.5 dB. In the +X direction, compared with an operation in the end-fire mode, an operation in the broadside mode may have a switching gain of 8.9 dB. In the high-frequency band, in the +Z direction, compared with an operation in a broadside mode, an operation in an end-fire mode may have a switching enhancement of 5.8 dB. In the +X direction, compared with an operation in the end-fire mode, an operation in the end-fire mode may have a switching gain of 6.2 dB.

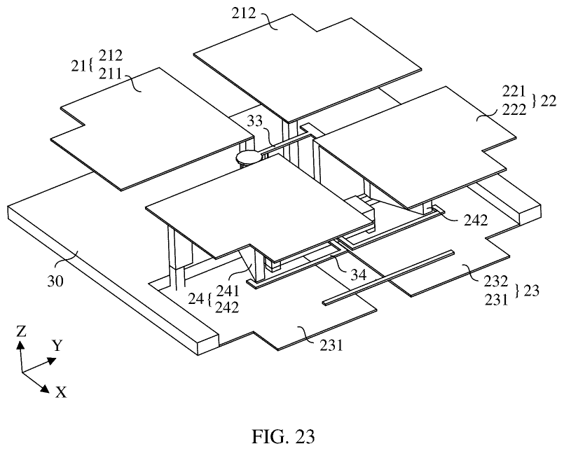

FIG. 23 is another schematic diagram of a structure of an antenna-in-module according to an embodiment of this application. As shown in FIG. 23, in some other implementations, the antenna-in-module 200 may be a horizontally polarized dual-band antenna. In this case, the antenna-in-module 200 may include four radiating elements 21 to 24, the second feed stub 32, and the fourth feed stub 34, and include only a broadside horizontally polarized antenna and an end-fire horizontally polarized antenna. The broadside antenna may support both a low-frequency band and a high-frequency band, and the end-fire antenna may also support both a low-frequency band and a high-frequency band. For structures and operating principles of the broadside horizontally polarized antenna and the end-fire horizontally polarized antenna, refer to the description of the dual-polarized pattern-switchable co-structured broadside and end-fire antenna. Details are not described herein again.

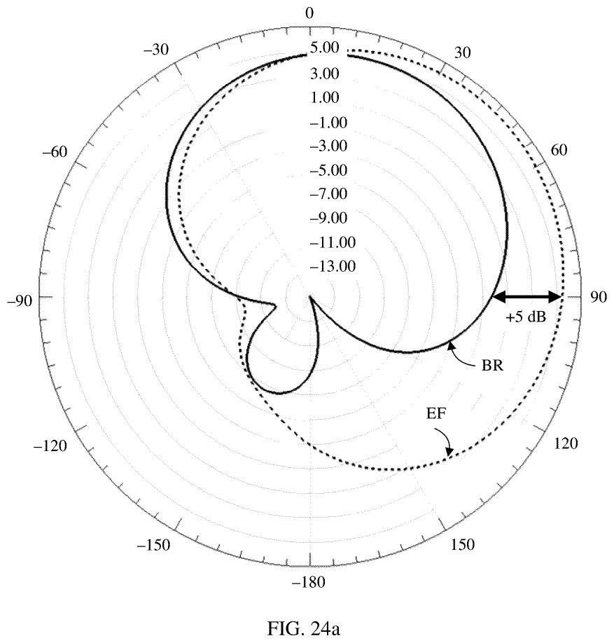

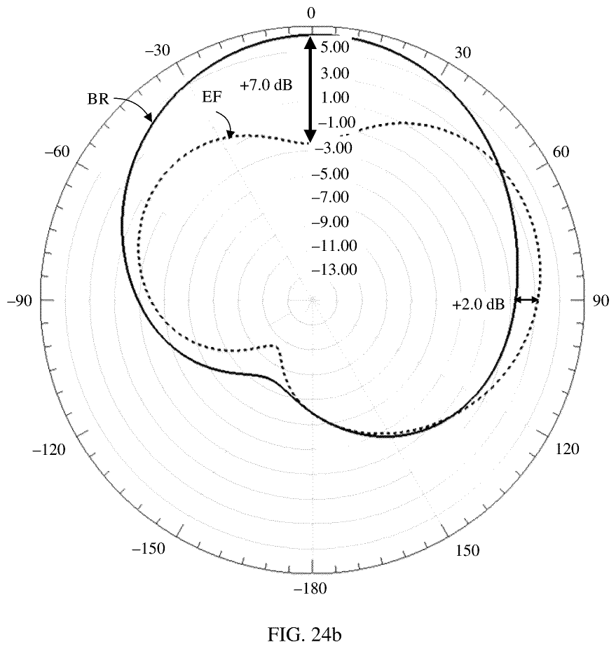

FIG. 24a is a diagram of a broadside and end-fire horizontal polarization radiation gain pattern of the antenna-in-module provided in FIG. 23 in a low-frequency band, and FIG. 24b is a diagram of a broadside and end-fire horizontal polarization radiation gain pattern of the antenna-in-module provided in FIG. 23 in a high-frequency band. The low-frequency band is a 29.0 GHz frequency band, and the high-frequency band is a 39.0 GHz frequency band. In the low-frequency band, in the +X direction, compared with an operation in an end-fire mode, an operation in a broadside mode may have a switching enhancement of 5 dB. In the high-frequency band, in the +Z direction, compared with an operation in an end-fire mode, an operation in a broadside mode may have a switching enhancement of 7.0 dB. In the +X direction, compared with an operation in the end-fire mode, an operation in the end-fire mode may have a switching gain of 2.0 dB.

In conclusion, the antenna-in-module provided in embodiments of this application may be a dual-polarized pattern-switchable co-structured broadside and end-fire antenna, or may be a vertically polarized dual-band antenna, or may be a horizontally polarized dual-band antenna. In the three implementations, compared with an antenna-in-module in which only a broadside antenna or only an end-fire antenna is disposed, the antenna-in-module provided in embodiments of this application can obtain an obvious antenna gain.

According to the antenna-in-module provided in embodiments of this application, the second radiating elements in the broadside antenna and the end-fire antenna are reused, to implement an antenna radiation pattern re-configurable through circuit control, so that the radiation pattern of the antenna-in-module may be a broadside pattern or an end-fire pattern, and the antenna-in-module supports dual-polarization in both radiation models. Compared with an antenna-in-module in the conventional technology in which only a broadside antenna is disposed, the antenna-in-module provided in embodiments of this application may be placed on a side of an electronic device without increasing an antenna area, and may further increase a radiation gain and a signal coverage angle. Compared with an antenna-in-module in the conventional technology in which only a broadside antenna and an end-fire antenna are directly placed adjacent to each other, the antenna-in-module provided in embodiments of this application can reduce an antenna area by at least 30%.

The antenna-in-module 200 provided in embodiments of this application is a millimeter-wave antenna module applied to a mobile phone. It should be understood that the antenna-in-module 200 provided in embodiments of this application may not be limited to being applied to the millimeter-wave antenna module. For example, the antenna-in-module 200 provided in embodiments of this application may be further applied to a base station antenna, a Wi-Fi sharer antenna, a head-mounted apparatus antenna, a spatial positioning antenna, a UWB (Ultra-Wideband, ultra-wideband) antenna, an IoT (Internet of Things, Internet of Things) antenna, and the like.

In an example, the antenna-in-module 200 provided in embodiments of this application may be applied to a base station antenna. Through co-structuring of the broadside antenna and the end-fire antenna, and switching between a broadside mode and an end-fire mode, each antenna element in the base station antenna can increase a radiation pattern in an end-fire direction without increasing the original area, so that a signal coverage range of a base station is effectively increased, or a quantity of base station antennas is reduced.

In another example, the antenna-in-module 200 provided in embodiments of this application may be applied to a ceiling-mounted or wall-mounted Wi-Fi sharer antenna. Though switching between a broadside mode and an end-fire mode, the broadside antenna radiation pattern can be connected to a user, or switched to the end-fire direction, to form a mesh grid with another home IoT appliance and another Wi-Fi sharer, so that indoor signal coverage is improved.

The foregoing descriptions are merely specific implementations of this application, but the protection scope of this application is not limited thereto. Any person skilled in the art can easily conceive modifications or replacements within the technical scope of this application, and these modifications or replacements shall fall within the protection scope of this application. When there is no conflict, embodiments of this application and the features in the embodiments may be mutually combined. Therefore, the protection scope of this application shall be subject to the protection scope of the claims.

1-20. (canceled)

21. An antenna-in-module, comprising:
a ground plate;
a first radiating element, wherein the first radiating element and the ground plate are arranged at an interval along a virtual Z-axis and are disposed opposite to each other;
a second radiating element, wherein the first radiating element and the second radiating element are arranged at an interval along a virtual X-axis, and a first gap between the first radiating element and the second radiating element extends along a virtual Y-axis;
a third radiating element, wherein the third radiating element and the second radiating element are arranged at an interval along the virtual Z-axis and are disposed opposite to each other, and the first radiating element, the second radiating element, and the third radiating element are separately in a coupling connection to the ground plate;
a first feed stub, wherein at least a part of the first feed stub is disposed in a first aperture, and the first aperture comprises space between the first gap and the ground plate; and
a second feed stub, wherein at least a part of the second feed stub is disposed in a second aperture, and the second aperture comprises space between the second radiating element and the third radiating element; and
wherein the virtual X-axis, the virtual Y-axis, and the virtual Z-axis are perpendicular to each other.

22. The antenna-in-module according to claim 21, wherein the first radiating element comprises a first radiator and a second radiator that are arranged at an interval along the virtual Y-axis, and a second gap between the first radiator and the second radiator extends along the virtual X-axis;
wherein the second radiating element comprises a third radiator and a fourth radiator that are arranged at an interval along the virtual Y-axis, and a third gap between the third radiator and the fourth radiator extends along the virtual X-axis; and
wherein the third radiating element comprises a fifth radiator and a sixth radiator that are arranged at an interval along the virtual Y-axis, and a fourth gap between the fifth radiator and the sixth radiator extends along the virtual X-axis.

23. The antenna-in-module according to claim 22, further comprising a third feed stub, wherein at least a part of the third feed stub is disposed in a third aperture, and the third aperture comprises the second gap and space between the third gap and the ground plate.

24. The antenna-in-module according to claim 23, further comprising:
a fourth radiating element disposed between the third radiating element and the second radiating element and in a coupling connection to the ground plate, wherein the fourth radiating element comprises a seventh radiator and an eighth radiator, the seventh radiator is disposed between the third radiator and the fifth radiator, and the eighth radiator is disposed between the fourth radiator and the sixth radiator; and
a fourth feed stub comprising a first feed structure and a second feed structure, wherein the first feed structure is in a coupling connection to the seventh radiator, and the second feed structure is in a coupling connection to the eighth radiator.

25. The antenna-in-module according to claim 24, comprising:
a first grounding element connected between the first radiator and the ground plate;
a second grounding element connected between the second radiator and the ground plate;
a third grounding element connected between the third radiator and the ground plate, wherein the third grounding element is connected to an end that is of the third radiator and that is adjacent to the first radiator; and
a fourth grounding element connected between the fourth radiator and the ground plate, wherein the fourth grounding element is connected to an end that is of the fourth radiator and that is adjacent to the second radiator, the seventh radiator is connected to the third grounding element, and the eighth radiator is connected to the fourth grounding element.

26. The antenna-in-module according to claim 25, wherein the third grounding element comprises a first ground wall and a second ground wall, the first ground wall and the second ground wall are respectively connected to the third radiator at a first position and a second position, the first position and the second position are arranged at an interval on the third radiator, the first ground wall is located on a side of the third radiator that is adjacent to the fourth radiator, the seventh radiator is connected to the first ground wall, and a first switch is connected between the second ground wall and the ground plate; and
wherein the fourth grounding element comprises a third ground wall and a fourth ground wall, the third ground wall and the fourth ground wall are respectively connected to the fourth radiator at a third position and a fourth position, the third position and the fourth position are arranged at an interval on the fourth radiator, the third ground wall is located on a side of the fourth radiator that is adjacent to the third radiator, the eighth radiator is connected to the third ground wall, and a second switch is connected between the fourth ground wall and the ground plate.

27. The antenna-in-module according to claim 26, wherein the third ground wall comprises a fourth ground segment, a fifth ground segment and a sixth ground segment that are sequentially connected, the fourth ground segment is connected to the fourth radiator, the sixth ground segment is connected to the ground plate, the fourth ground segment and the sixth ground segment extend along the virtual Z-axis, and the fifth ground segment extends along a virtual XY plane.

28. The antenna-in-module according to claim 22, further comprising:
a third switch connected between the fifth radiator and the sixth radiator, wherein the third switch is located at an end that is of the third radiating element and that is further away from the first radiating element than an end of the third radiating element that is adjacent to the first radiating element; and
a fourth switch connected between the third radiator and the fourth radiator, and the fourth switch is located at an end that is of the second radiating element and that is adjacent to the first radiating element.

29. The antenna-in-module according to claim 25, wherein a major axis of both the seventh radiator and the eighth radiator are disposed perpendicular to the ground plate, a first end of the seventh radiator is connected to the third grounding element, a second end of the seventh radiator extends toward a side that is further away from the eighth radiator than a side that is adjacent to the eighth radiator, a first end of the eighth radiator is connected to the fourth grounding element, and a second end of the eighth radiator extends toward a side that is further away from the seventh radiator than a side that is adjacent to the seventh radiator.

30. The antenna-in-module according to claim 22, wherein the first feed stub extends along the virtual X-axis, a projection of a first end of the first feed stub on a virtual XY plane is located within a projection of the second gap on the virtual XY plane, and a projection of a second end of the first feed stub on the virtual XY plane is located within a projection of the third gap on the virtual XY plane; and
wherein the second feed stub extends along the virtual Z-axis, and an end of the second feed stub is in a coupling connection to the second radiating element.

31. The antenna-in-module according to claim 23, wherein the first gap comprises a first sub-gap and a second sub-gap, the first sub-gap is located between the first radiator and the third radiator, the second sub-gap is located between the second radiator and the fourth radiator, the third feed stub extends along the virtual Y-axis, a projection of a first end of the third feed stub on a virtual XY plane is located within a projection of the first sub-gap on the virtual XY plane, and a projection of a second end of the third feed stub on the virtual XY plane is located within a projection of the second sub-gap on the virtual XY plane.

32. The antenna-in-module according to claim 25, wherein the first grounding element comprises a first ground segment, a second ground segment, and a third ground segment that are sequentially connected, the first ground segment is connected to the first radiator, the third ground segment is connected to the ground plate, the first ground segment and the third ground segment extend along the virtual Z-axis, and the second ground segment extends along a virtual XY plane.

33. The antenna-in-module according to claim 21, wherein the third radiating element reuses a partial structure of the ground plate.

34. The antenna-in-module according to claim 24, comprising:
a broadside antenna comprising the first radiating element, the second radiating element, the first feed stub, the third feed stub, and the ground plate; and
an end-fire antenna comprises the second radiating element, the third radiating element, the fourth radiating element, the second feed stub, the fourth feed stub, and the ground plate.

35. The antenna-in-module according to claim 34, wherein the broadside antenna comprises a broadside-vertical polarization pattern and a broadside-horizontal polarization pattern, the first feed stub feeds the first radiating element and the second radiating element to form the broadside-vertical polarization pattern, and the third feed stub feeds the first radiating element and the second radiating element to form the broadside-horizontal polarization pattern; and
wherein the end-fire antenna comprises an end-fire vertical polarization pattern and an end-fire horizontal polarization pattern, the second feed stub feeds the second radiating element and the third radiating element to form the end-fire vertical polarization pattern, and the fourth feed stub feeds the fourth radiating element to form the end-fire horizontal polarization pattern.

36. The antenna-in-module according to claim 22, wherein each of the first radiator, the second radiator, the third radiator, and the fourth radiator is shaped like a rectangle with a missing corner, and the first radiator, the second radiator, the third radiator, and the fourth radiator are centrosymmetric with respect to a center point.

37. An electronic device, comprising an antenna-in-module, the antenna-in-module comprising:
a ground plate;
a first radiating element, wherein the first radiating element and the ground plate are arranged at an interval along a virtual Z-axis and are disposed opposite to each other;
a second radiating element, wherein the first radiating element and the second radiating element are arranged at an interval along a virtual X-axis, and a first gap between the first radiating element and the second radiating element extends along a virtual Y-axis;
a third radiating element, wherein the third radiating element and the second radiating element are arranged at an interval along the virtual Z-axis and are disposed opposite to each other, and the first radiating element, the second radiating element, and the third radiating element are separately in a coupling connection to the ground plate;
a first feed stub, wherein at least a part of the first feed stub is disposed in a first aperture, and the first aperture comprises space between the first gap and the ground plate; and
a second feed stub, wherein at least a part of the second feed stub is disposed in a second aperture, and the second aperture comprises space between the second radiating element and the third radiating element; and
wherein the virtual X-axis, the virtual Y-axis, and the virtual Z-axis are perpendicular to each other.

38. The electronic device according to claim 37, wherein the first radiating element comprises a first radiator and a second radiator that are arranged at an interval along the virtual Y-axis, and a second gap between the first radiator and the second radiator extends along the virtual X-axis;
wherein the second radiating element comprises a virtual third radiator and a virtual fourth radiator that are arranged at an interval along the virtual Y-axis, and a third gap between the virtual third radiator and the virtual fourth radiator extends along the virtual X-axis; and
wherein the third radiating element comprises a fifth radiator and a sixth radiator that are arranged at an interval along the virtual Y-axis, and a fourth gap between the fifth radiator and the sixth radiator extends along the virtual X-axis.

39. The electronic device according to claim 38, wherein the antenna-in-module further comprises a third feed stub, at least a part of the third feed stub is disposed in a third aperture, and the third aperture comprises the second gap and space between the third gap and the ground plate.

40. The electronic device according to claim 37, wherein the electronic device comprises a front side and a back side that are disposed opposite to each other, the front side and the back side are connected by a middle frame, and the middle frame comprises a top, a right side part, a bottom, and a left side part that are sequentially connected; and
wherein there are three antennas-in-module, a first antenna-in-module is disposed on the back side of the electronic device and a distance between the first antenna-in-module and an upper edge of the top does not exceed a first threshold, and a second antenna-in-module and a third antenna-in-module are respectively disposed on the left side part and the right side part and a distance between the second antenna-in-module and a left edge of the left side part and a distance between the third antenna-in-module and a right edge of the right side part do not exceed a second threshold.
